(19) United States
(12) Patent Application Publication
(10) Pub. No.: US 2025/0180191 A1
(43) Pub. Date: Jun. 5, 2025

(54) SUSTAINABLE LED LUMINAIRES AND SYSTEMS FOR RECYCLING, REUSE, AND PACKAGING REDUCTION

(71) Applicants: Wes Fannin, Greenvile, WI (US); Adam Chetakian, San Clemente, CA (US)

(72) Inventors: Wes Fannin, Greenvile, WI (US); Adam Chetakian, San Clemente, CA (US)

(21) Appl. No.: 19/031,840

(22) Filed: Jan. 18, 2025

Related U.S. Application Data
(63) Continuation-in-part of application No. 18/916,573, filed on Oct. 15, 2024.
Application No. 18/916,573 is a continuation-in-part of application No. 63/459,504, filed on Apr. 14, 2023.
(63) Continuation-in-part of application No. 18/374,572, filed on Sep. 28, 2023, now Pat. No. 12,169,055.
(60) Provisional application No. 63/453,650, filed on Mar. 21, 2023.
(60) Provisional application No. 63/466,162, filed on May 12, 2023.
(60) Provisional application No. 63/469,341, filed on May 26, 2023.
(60) Provisional application No. 63/459,504, filed on Apr. 14, 2023.
(60) Provisional application No. 63/453,650, filed on Mar. 21, 2023.
(60) Provisional application No. 63/466,162, filed on May 12, 2023.
(60) Provisional application No. 63/469,341, filed on May 26, 2023.

(51) Int. Cl. F21V 19/00; F21S 2/00; F21V 23/00; F21Y 115/10; G06Q 10/20

(52) U.S. Cl. CPC F21V 19/003; F21S 2/005; F21V 23/005; G06Q 10/20; F21Y 2115/10

(57) ABSTRACT

A method is described in which LED luminaires having removable modular component chassis can be readily replaced, repaired, or upgraded by sending replacement component chassis that provide desired features, while receiving the prior modular component chassis which are then stored and recycled or upcycled for future use. In such a system, a customer can request a replacement component chassis having one or more specified features, and then receive a suitable replacement that has been recycled or upcycled from a previous component chassis.

### CROSS-REFERENCE TO RELATED APPLICATIONS

U.S. patent application Ser. No. 18/916,573, “Smart LED Luminaires for Safety Systems,” filed Oct. 15, 2024; U.S. Provisional Patent Application Ser. No. 63/459,504, “LED Luminaires for Safety Systems,” filed Apr. 14, 2023; U.S. Provisional Patent Application Ser. No. 63/453,650, “LED Luminaire Replacement and Retrofit Units,” filed Mar. 21, 2023; U.S. Provisional Patent Application Ser. No. 63/466,162, “Universal LED Drivers,” filed May 12, 2023; and U.S. Provisional Patent Application Ser. No. 63/469,341, “Mobile Networks and Smart Luminaires for Safety Systems,” filed May 26, 2023, each of which are hereby incorporated by reference in their entirety.

### FIELD OF THE DISCLOSURE

The present disclosure pertains to LED luminaires, LED lights, light fixtures, systems, and methods of use that include modular or replaceable LED systems that can be replaced, modified, or upgraded rapidly and conveniently, as well as systems for recycling, reusing, repairing, upgrading, and replacing LED systems. Related systems for sustainable packaging and packaging reduction pertaining to LED lights are also included within the field of the disclosure.

### BACKGROUND

While light emitting diode (LED) lights offer many advantages in terms of efficiency and sustainability over older lighting systems, the rapid pace of technological innovation has also led to increased electronic waste as older lighting systems are regularly discarded in favor of newer, more efficient models, or as existing LED systems fail or otherwise need to be updated, replaced, or repaired. This has raised concerns about sustainability and the environmental impact of lighting systems.

There is thus a need for improved systems that may, for example, reduce waste and improve sustainability, by achieving, by way of example only, one or more of the following: 1) reducing the volume or mass of waste from discarded electronic components, 2) reducing packaging waste and expense when shipping LED luminaires or components thereof, 3) reducing lost time and productivity in repairing, upgrading, or replacing a lighting system or individual luminaires, and 4) reducing resources required in repairing, upgrading, or replacing a lighting system or individual luminaires.

While there is an increasing trend to retrofit or replace fluorescent light fixtures or other lighting systems with LED lights, some customers errantly assume that the lights might have essentially unlimited lives. They will likely later discover that LED lights can fail or need service due to various problems such as poor thermal management causing failure from LED chips overheating, failure of LED drivers, the need to upgrade drivers, the need to upgrade printed circuit boards (PCBs), the need to add controls or to improve color, intensity, or other features, all of which may lead to the need to replace or upgrade old systems. Some customers purchase LED systems with basic control systems or no control at all (they may be optional third-party add-ons), understanding that they can later add more sophisticated controls when needed, only to find that accessing the driver or other hardware in order to add an upgraded control system is a difficult operation.

In general, replacing, repairing, or upgrading LED systems can be costly and inefficient, in part because access to components such as drivers may require accessing troffers from above, which can be inconvenient or dangerous, or infeasible for some ceilings. It may require disassembling complex structures involving the use of tools, the potential for lost parts, the risk of injury, the need to turn off electrical power, and general lost time and lost productivity for the complex task. In many cases, a professional electrician is needed to cope with power issues. There is a need for improved LED systems that mitigate one or more of these or related problems and make the task of modifying an LED system more convenient and less costly.

Another common problem in the lighting industry is that upgrading performance of lights (e.g., installing upgraded LED lights with improved efficiency, color, lifetime, etc., or installing improved drivers or other improved components) typically involves discarding the entire troffer (the frame and the associated components), resulting in unnecessary waste going to landfills. This also involved extensive labor to remove old units and to deal with the wiring or other tasks involved in installing new units. There is a need for more environmentally friendly solutions that reduce solid waste and reduce wasted time to replace, upgrade or repair lights.

A related issue is that packaging for troffers and LED components can be bulky and wasteful. There is a need for improved ways of providing LED components that reduce packaging waste and other costs, and in general reduce environmental harms associated with shipping bulky goods.

The solutions discussed herein in many aspects may address one or more of the previous problems noted here or others discussed or implied hereafter, but it is not necessary for any aspect as claimed to resolve all or any of the various problems mentioned or alluded to herein in order to be within the scope of the claims.

### SUMMARY

A method and LED lighting system are provided that employ modular LED luminaires designed for sustainable operation, repair, and upgradeability. The system includes LED luminaires that are each provided with a modular component chassis that can be readily removed, repaired, upgraded, or replaced, in some aspects without the need for specialized tools or any tools at all, and/or without the need for a power shutdown that would affect other lights or equipment when an existing component chassis is removed or replaced. In some aspects, the removal, repair or upgrade can be done without a need for accessing the space above a luminaire, for such changes can be made by a person located beneath the luminaire by simply accessing and removing the component chassis from below due to its design features, to be discussed hereafter.

In some aspects, after customers return one or more used chassis to a service provider that may be associated with the manufacturer, vendor, or agents thereof), typically by shipping the used chassis to a service facility or other location, the one or more chassis may be tested, repaired, or upgraded for reuse at a worksite which may be at or near the service facility. This may happen before, after, or while the one or more chassis are stored in a storage repository after they have been received by the service provider. Information about each component chassis including the identity of the user (e.g., an owner, renter, or leaser of the component chassis or of the related LED luminaires) may be recorded in a database, such that the component chassis may be retrieved and prepared to be sent back to a user upon receipt of a request for an upgrade, repair, or replacement.

Instead of discarding entire LED luminaires or major components that create unnecessary waste, the more sustainable process minimizes waste and supports a sustainable lifecycle for the luminaires as a user's LED luminaire or components thereof are stored for future use. Previously obtained components such as the component chassis are sent back in upgraded or repaired form in response to a service request. This may involve, for example, rivet-free and weld-free attachments of components to the substrate of a component chassis and the use of quick-connect connections or easily removed connections such as screws, snaps, etc. In one aspect, a component chassis is rivet free, or at least has no rivets or welds connecting the LED driver to the substrate or LED strips to the substrate, and may have no rivets or welds to attach other electronic components such as battery backup units, external switch components that control settings for the LED lights, added devices such as microphones, motion detectors, shot detectors, cameras, etc. Further, the compact, stackable design of the luminaires and chassis facilitates efficient shipping and storage, allowing components for multiple luminaires to be provided in a single box, thereby enhancing sustainability.

Also disclosed is a streamlined logistical process or an LED management system for improved sustainability with respect to LED lighting. This logistical process comprises use of a repository for storing component chassis. The repository may comprise a facility at a single location or may comprise two or more facilities such as buildings or warehouses that may each individually receive and store any one or more of the following: one or more component chassis sent by a customer, one or more new component chassis, one or more component chassis that have been received from the customer or other customers and that have been modified such as having been repaired or upgraded. When repository facilities involve more than one location, the locations may be nearby, such as within a radius of 2, 10, 20, 50, or 100 km, but can be more distant when needed. The logistical process may also comprise a worksite for updates or repairs, which also may be nearby one or more locations of the repository, including being located with or adjacent to a facility of the repository.

The logistical process may also employ a shipping operation conducted at one or more shipping facilities that may be near to or within at least one of the group consisting of a worksite and a repository facility. The shipping operation ships upgraded or recycled chassis back to customers. This may naturally involve one or more intermediate entities and facilities, and may be conducted by a third party that takes and ships prepared packages or even packs LED luminaire materials according using provided or specified materials according to specific instructions before shipping the materials. The instructions may dictate the methods of packing to achieve a sustainable packaging target such as packing 4-8 luminaires or 4-20 component chassis in a single carton. A database tracks the received chassis, associating them with their respective owners and configurations, enabling precise customization and record-keeping.

The logistical process typically involves a service request from the customer with respect to a first LED luminaire. When the service request only involves the component chassis and does not require a modification of the frame, only the component chassis needs to be shipped to the service provider.

The service request can be generated and transmitted in many ways. In some aspects, an automated system may detect the need for repair, replacement, or upgrading and may then automatically issue the service request electronically or by other means to the service provider, which may then be automatically processed. A suitable component chassis meeting the customer's needs as expressed in or related to the service request can then be identified and quickly shipped to the customer. This may be done before the customer removes or ships the first component chassis.

Thus, in one aspect, an LED management method related to the above-mentioned logistical process is provided comprising, in any logical order: receiving from a customer a first component chassis having a first set of features (in the case of a repair, the set of features can include the fact that one or more components of the first component chassis have malfunctioned and are in need of repair or replacement); receiving a service request from the customer that can be fulfilled with a second component chassis having a second set of features; sending the second component chassis having the second set of features to the customer; storing the first component chassis in a repository. In one variation of this aspect, the second component chassis is a used component chassis that has been previously received from the customer and had been stored in a repository, and may have been modified according to the service request to provide it with the second set of features. In another variation of this aspect, the second component chassis is a used component chassis that has been previously received from another customer and has been modified if necessary according to the service request to provide it with the second set of features. In some aspects, the first and second set of features may be essentially the same or exactly the same, apart from any failures or defects that have occurred.

In essence, in light of such aspects, when a service request is made for which a second component chassis in the repository may be suitable, the second component chassis may be rapidly prepared (e.g., adding any needed features or removing features that are not needed) and shipped to the customer, who in turn ships component chassis in need of replacement, repair, or upgrade back to the service provider where it can be prepared for future use by the customer or other customers if needed, thus greatly reducing waste.

In a related aspect, two or more manufacturers may collaborate in a network in which previously used components from the two or more manufacturers are stored in one or more repositories, as the two or more manufacturers cooperate in sharing some resources and systems to make it easier for customers to manage multiple types of LED lights in a more sustainable way, allowing used components to be returned and, when needed, to be upgraded or repaired for future use, and to be stored in a repository. A single database or multiple databases may be used to track stored materials in this network and to associate them with their prior owners for future use by those prior owners when feasible.

A modular LED luminaire adapted for mounting in a ceiling or other location includes a frame having a recess, which may be a central recess, for receiving a detachable LED component chassis, which in some aspects may substantially span the length or width of the frame, and which may have a front side with LED lights and a back side having other components such as an LED driver, a receptacle for connection to a power line, and other modules as desired including sensors (cameras, microphones, motion detectors, air quality sensors, light sensors, gunshot detectors, etc.), one or more radios, switches for adjusting settings, surge suppressors, backup power supply, etc., which may be plugged in or otherwise easily attached or disconnected, as desired.

In some aspects, the component chassis and, if desired other components of a luminaire such as the frame, lens, etc., may be associated with scannable identifying information. For example, a unique (e.g., serialized) QR code, bar code, RFID tag, NFC tag, or any other scannable identifier may be provided on the component chassis in any useful form such as a printed code adhesively adhered, a printed code directly applied to a component via printing with ink, laser marking, embedding or attaching an RFID or NFC tag, etc. When the component is scanned, a database entry can be made identifying its location, owner, pending actions, etc.

Thus, when a luminaire or component chassis is installed, the installer may be instructed to scan each component chassis and other components as desired such as the frame with a suitable scanner such as a cell phone, an RFID reader, and NFC reader, a QR or barcode reader, etc., wherein the reader is cooperatively associated with a location identified such as a GPS device, the GPS system of a cell phone, a triangulation system based on local WIFI routers, other satellite signals, etc. Upon installation, the unique identification codes are scanned providing information about the location of the component chassis and luminaire, if desired, such that a database entry in an LED management system is made indicating the precise uniquely identified item, the company and facility associated with the owner or user, the location in the facility, the date of installation, etc. This database then provides geospatial information and owner/user information for the LED devices that have been installed.

Later, when there is a need for an upgrade, replacement, or repair, the component such as a component chassis can be scanned and returned to a facility managed by or in cooperation with the vendor or manufacturer. Upon scanning, the vendor or manufacturer or agent thereof is alerted that the item is being returns and the desires of the owner or user can be interrogated to ensure that proper action is taken. Thus, the manufacturer or vendor may immediately ship a replacement part taken from its inventory of items received for reuse. For example, previously returned items from the user or owner may then be retrieved and provided with the appropriate upgrades or refurbishment to adequately replace the item then being returned, The items to be sent may be from a central collection facility or local collection and refurbishment facilities near the geophysical location of the user/owner.

Further, the history of items being sent to the user/owner or returned the vendor/manufacturer can be recorded and provided to the owner/user or others, as desired, such that Life Cycle Assessment analysis can be performed on the items or the class of LED lights showing how many LED lights have been recycled or upcycled, and showing what carbon footprint reduction has been achieved with concrete data for LED lighting system.

In some cases, the vendor or manufacturer can provide basic calculations for individual or aggregate LED systems over time showing how the method of using easily detached and replaced component chassis can reduce waste, reduce carbon emissions, and meet high standards of sustainability.

### The Modular LED System

When installed for normal use, the component chassis may be attached to the frame by one or more first engaging elements on one side of the component chassis that are adapted to connect to a portion of the frame, and by one or more second engaging elements on one or more other sides of the component chassis. When the one or more second engaging elements are disconnected from the frame, the detachable component chassis is adapted to be partially detached from the frame while one portion thereof remains connected to the frame, such that the partially detached component chassis can be swung or rotated about an axis or point near the region where the connection is maintained by the one or more first engaging elements and thus remain securely connected with the back side of the component chassis thereby accessible for treatment. In this “open” orientation, the component chassis is still attached to the frame via a connection in the form of one or more first engaging elements, which may be rotatable or may be flexible or rigid, and while “open” can be readily and conveniently serviced or treated as needed for repair, replacement of components, upgrading, adjusting settings, etc., and then be swung or rotated back into position against the frame such that the one or more first engaging elements continue to connect the component chassis to the frame, and such that the one or more second engaging elements can then be connected once again to the frame to secure the component chassis in place in a fully attached mode.

Such systems for attaching and detaching components simplifies installation, upgrading, repair, and removal of LED lights and portions thereof. Further, the ability to replace a component chassis without having to remove a troffer or frame greatly reduces what needs to be shipped and handled when LED lights need to be upgraded, repaired, or replaced.

In some aspects, an LED management method is provided wherein the hardware of an LED light can be repurposed efficiently to reduce waste and increase sustainability. In this method, a customer employing LED lights having a removable component chassis such as a modular component chassis can request an upgrade or repair for one or more LED lights, the upgrade or repair providing one or more desired features (e.g., enhanced power usage, modified light output, additional sensors, improved LED driver, battery backup, etc.), and then rapidly receive a shipment having one or more component chassis with the desired features. In some aspects, the shipment comprises an efficiently packaged stack of a plurality of component chassis that take far less space (e.g., less than 60%, 50%, 40%, or 35% of the space) than complete LED lighting systems that include the frame or troffer. In some aspects, at least 4, 6, or 8 component chassis can fit into a box with a thickness no greater than 16 inches, 14 inches, or 12 inches.

Because replacement of an LED luminaire using the LED luminaires described herein generally does not require the entire troffer or frame to be shipped, only the modular component chassis which is much less wide than the LED luminaire is, it is possible that i sending a customer a number of replacement modular component chassis, the service provider can ship one or more compact packages comprising one or more (e.g., at least four, or from four to six or four to eight) refurbished component chassis in a box having at least one dimension that is less than half the distance required to hold a single luminaire including the frame, due to the component chassis being much less wide than a frame. (In a two-foot by four-foot luminaire, the width in question would be two feet, and four feet would generally be considered the length.)

The prior one or more component chassis being replaced can then be quickly removed, in some aspects without the need for tools or without the need for an electrician to remove the component chassis, and the newly received component chassis with the one or more desired features can likewise be easily installed, in some aspects again without the need for tools or without the need for an electrician to remove the component chassis.

The one or more prior component chassis can then be returned to a service provider (e.g., a service facility cooperating with the manufacturer or vendor) where that one or more prior component chassis will be repurposed such as being “upcycled” (improved and made available for future use in an LED lighting system rather than being discarded, though outdated, worn, or inoperative components of the component chassis may be discarded or recycled in traditional ways). The upcycled component chassis may, for example, be given an added module or a new module to replace an outdated or malfunctioning module (e.g., replacing an old LED driver). In some aspects, the received one or more prior component chassis are stored and associated (e.g., via a database) with the customer who sent them and/or with the facility from which they were removed, such that when further that customer or facility requires another similar component chassis, one or more of the stored component chassis can be provided again to the customer, once the hardware, software, or rights to the desired features have been provided such that the customer can receive and install the once-stored component chassis (with whatever modifications were made to it). In this way the carbon footprint of the received upcycled component chassis is greatly reduced and overall waste is greatly reduced. A database can track the provenance and history of each component chassis as it is used and upcycled, helping clients demonstrate that their lighting systems employ upcycled components with low carbon footprint, and thereby facilitating detailed life cycle assessment (LCA) analysis.

In some aspects, the one or more second engaging elements may be movable, i.e., have a movable element that makes the connection to the frame, such as a sliding member, a rotating latch, a key-and-lock mechanism, a snap-fit connection, or geometric interlock (e.g., interlocking parts such as a male-female connection, dovetail connection, etc.), etc. In some aspects, the one or more first engaging elements may be comprise a flexible member such as a flexible rod, flexible beam, cable, chain, tether, etc. that forms a bendable or flexible connection, or may comprise a rigid structure that forms a connection that nevertheless may be rotated relative to the frame, such as a mechanical interlock adapted to remain securely connected in two or more geometrical orientations or a hook that engages with a ring, rod, or bar wherein the hook can rotate its orientation with respect to the ring, rod, or bar while still remaining engaged. In some aspects, however, the one or more second engaging elements are not a cable, cord, or tether, but have a rigid element adapted to engage with a portion of the frame or a rigid structure such as a rail connected to the frame.

As a form of a bendable connection, a tether may join the component chassis to the frame, such as a length of flexible cord, chain, cable tie, or wire that may be secured to the backside of the substrate (this may be a one-piece metal or composite structure that serves hold the LED lights and the LED driver in place, along with other components) and have a loop, ring, snap, tab, finger, protrusion, or other attachment means on the frame that it can join to. Such tethers may include an adjustable or tightenable tether that can be made taut when needed. For example, tightening and securing may be done with a cable tie with a ratcheting or one-way closure mechanism, a cord tied with a taut-line hitch knot or other adjustable or slidable knots, or mechanical devices such as a cam buckle, ratchet strap, cleat for securing a cord or cable, turnbuckle, cord lock, sliding clamp or grip, wire rope clamp, various grips and clamps, etc. The tether may extend from a structure such as a pin, hook, ring, finger, ledge, screw, loop, slot, protrusion, clamp, tie, bolt, etc. on the component chassis to connect to a structure such as a pin, hook, ring, finger, ledge, screw, loop, slot, protrusion, clamp, tie, bolt,, etc. on the frame, thereby providing a secure connection that can be rotated relative to the frame and continue to securely hold the component chassis in place in a second orientation wherein the one or more second engaging elements are disconnected from and remote from the frame, thereby making the back of the component chassis more available in the second orientation, especially to a person standing below the frame. In some cases, the tether or other components of the one or more first engaging elements may be loosened, extended, or otherwise adjusted prior to or during the process of moving the component chassis from its first orientation to the second orientation with the one or more second engaging elements disconnected and remote from the frame, and they then can be tightened again to better secure the component chassis when it is moved to the first orientation, or before or after it is moved to the first orientation. But in some aspects, adjustment of the tether or other connections is not needed when moving from the first to the second or from the second to the first orientation.

In some aspects, the fully attached LED component chassis is held in place with respect to the frame by the one or more first engaging elements on one side of the component chassis acting in cooperation with one or more second engaging elements that may be on one or more other sides of the component chassis such as on a second side opposing the first side of the component chassis. In some aspects, the fully attached component chassis is converted to the partially detached “open” state by releasing or detaching the one or more second engaging elements, then swinging or rotating the component chassis about an axis or point near the one or more first engaging elements that are adapted to remain securely connected to the frame after the component chassis is swung or rotated about an angle greater than 10 degrees, 20 degrees, 30 degrees, or 45 degrees, such as from 25 degrees to 130 degrees relative to the plane of the component chassis when it is fully attached and in position against the frame, thereby exposing the back side of the component chassis for convenient treatment while remaining secured to the frame through the rotatable one or more first engaging elements. This process of converting the fully attached component chassis to the partially detached but still secured “open” orientation can, in some aspects, be done without the use of tools and in some aspects, can be done with one hand.

In one aspect, the one or more first engaging elements may have multiple parts such as two parts, with a first part adapted for connecting the component chassis to the frame when the component chassis is in the first orientation (e.g., fully attached to the frame, with the component chassis largely in the plane defined by the outer portions of frame generally visible to a viewer looking at the installed LED luminaire) and a second part adapted for connecting the component chassis to the frame when the frame is in the second orientation. For example, a ceiling-mounted frame may hold the component chassis in place with an L-shaped rigid structure extending from a first side of the component chassis that catches the metal wall surrounding an opening in the recess of the frame of the LED luminaire, but once the opposing one or more second engaging elements are disconnected, the component chassis may be lifted slightly to remove the one or more first engaging elements of the component chassis from the frame, and then a different component on the frame or on the component chassis or both may be used to suspend the component chassis from the frame as the component chassis hangs from its first edge from the frame. In such an example, a second part of a first engaging element of the component chassis may have one or more rings mounted to the first edge of the component chassis or to the back side of the component chassis that can be slide into or engage with fingers or hooks that project from the frame such as from the first edge of the recess of the frame, which allow a mechanical connection between the frame and a suitable side of the component chassis, thereby providing access to the back side of the component chassis and allowing a technician to carry out desired operations or treatments without the need to hold the component chassis. In some aspects, however, the one or more first engaging elements are one-part systems, meaning the same components are adapted to hold the component chassis in place against the frame as it is moved from a first to a second orientation which differ by an angle of at least 10, 15, or 20 degrees, etc.

The frame and the component chassis may each have a front side, generally the side from which light is radiated, which, for ceiling mounted luminaires, is generally the side towards the floor below. The frame and the component chassis also may each have an opposing back side, which, for ceiling mounted luminaires, may be the side towards the ceiling, and, for the component chassis, may be the side where the LED driver is mounted. The frame may serve as a housing for the component chassis and may have a recess or opening for receiving the component chassis, which can be securely attached to the frame by the one or more first and second engaging elements.

The novel design of the component chassis allows for its removal and replacement without necessitating the detachment of the entire frame, and in some aspects, the component chassis can be partially detached from the frame while one portion of the component chassis remains attached to the frame, allowing an operator to access components that are not normally accessible when the component chassis is fully attached to the frame (e.g., the back side of the component chassis). Such components may include the LED driver, a settings panel for adjusting the settings of the LED lights such as temperature or wattage, the power line that attaches to a connector or receptacle of the component chassis, or connectors adapted to receive a sensor, radio, etc. Thus, in such aspects, an operator can work on the back side or, in related aspects, on either side of the component chassis without having to remove the entire luminaire or without having to hold a detached component chassis, and detachment and attachment may be achieved without the need for tools.

The one or more first engaging elements, in some aspects, are adapted to suspend the component chassis from the frame (e.g., when mounted in or on a ceiling) or otherwise maintain connection between the component chassis and the frame when the one or more second engaging elements are detached and the component chassis is partially rotated away from the frame to expose the rear side of the component chassis to a worker positioned at the front of the frame. The first and second engaging elements may be on opposing sides such as the long sides or short sides of the component chassis, but need not be. For example, the one or more first engaging elements may be on a long side of the component chassis while the one or more second engaging elements are on one or two of the shorter sides or on three other sides of the component chassis, and vice versa. The one or more second engaging elements may also be movable such as a slidable lock, a rotating latch, a sliding latch, a deadbolt lock, etc., but may also employ magnets, mechanical interlocks, etc.

In some aspects, a connection between the component chassis and the frame, whether involving a first or second engaging element, but particularly a first engaging element, may be formed by the interaction of a solid surface attached to the frame adapted for connection with a rigid or flexible structure attached to the component chassis, whereby once the connection is formed, the rigid or flexible structure of the component chassis may move to a new orientation as the component chassis is swung or rotated to a new orientation or position relative to the frame, resulting in the connection being maintained and able to bear the load of the component chassis without further support from, say, human hands or an external object propping up the component chassis. For example, the solid surface attached to the frame may be an opening in the wall of the frame in a recess of the frame adapted to receive the component chassis, or it may be a hook, a ring, a rod or bar, a swiveling component such as a ball socket adapted to receive a rod or a rotatable socket for receiving a snap-in connection, a hook, rod, ring, etc. onto which a cable tie, chain, or flexible member can be attached that is also attached to the component chassis, thereby providing for rotation by the bending or other motion of the flexible member, etc.

The recess of the frame may comprise a first edge with one or more openings for receiving one or more first engaging elements and a second edge, such as an opposing edge, with one or more openings adapted to receive one or more second engaging elements. The recess may have a back surface with one or more openings adapted to receive a power cord or other cables or to serve other purposes, as desired. In some aspects, the recess need not be enclosed by solid material but may be largely open, such as open over the entire body of the component chassis or over at least 50% of the region above the component chassis. In some aspects at least portions of the recess are covered with solid material such as metal or plastic to protect the component chassis, and in such aspects at least 50%, 60%, 70%, 65%, 80%, or 85% of the space above the component chassis (speaking here of am LED luminaire in the horizontal orientation as in a ceiling mount) is covered by solid material associated with the frame (e.g., part of the frame). In aspects in which the recess largely lacks a back surface, the first and second edges of the recess of the frame may only be present where connections with the component chassis are needed.

In some aspects, the first and second edges of the recess of the frame form an obtuse angle relative to the plane of the frame such as from 90 degrees to 140 degrees, or from 100 degrees to 135 degrees. In some aspects, both the first and second edges of the recess each have one or more openings adapted to receive the first engaging elements and one or more openings adapted to receive the second engaging elements, such that there are suitable openings on both the first and second sides of the recess to receive the first and second engaging elements regardless of how the component chassis is oriented when it is installed (i.e., it can be revolved 180 degrees about a centerline passing through and normal to the plane of the component chassis and still be securely fastened as its first and second engaging elements successfully interact with the openings of the recess of the frame or with other aspects of the frame, such as a mounted rail or other structure adapted to engage with the first and/or second engaging elements of the component chassis. In some aspects, the first edge of the recess may be a mirror image of the second edge of the recess, and either edge can serve as the first edge based on which edge receives the first engaging elements of the chassis.

Thus, in one aspect, the first edge of the recess of a frame is adapted to receive a first engaging element from a first side of the component chassis. The first engaging elements may have tabs or projections that may, for example, have an L-shape, a hook shape, a curled lip, or the like to guide interaction with the edge of the recess of the frame and, in some aspects, to also hold the component chassis in place in, for example, a hanging position, as the component chassis is being adjusted (e.g., adjusting settings on the driver such as LED color or wattage), upgraded (e.g., adding a sensor or other device such as a Bluetooth radio, motion sensor, microphone, camera, and the like), repaired (e.g., replacing a surge suppressor or fuse, LED driver or driver elements, damaged LED light strip, etc.), installed, replaced, or removed (all such actions may be included when speaking of the component chassis as being “treated” or receiving “treatment”). Thus, the one or more openings in the first edge of the recess of the frame can not only receive the engaging elements from the component chassis to hold it in place during regular operation of the LED luminaire (e.g., in a horizontal orientation while the frame is also in a horizontal orientation to provide light to a region below), but during repair, upgrading, or replacement of the component chassis, components of the component chassis, or other aspects of the LED luminaire or during modifications to the wiring to or from the LED luminaire, the one or more openings in the first edge of the recess of the frame can serve to hold the component chassis in place while it is temporarily in a different orientation for treatment of the component chassis.

Such a different orientation may include a substantially vertical orientation of the component chassis, hanging from the substantially horizontal frame by the first side of the component chassis (or rising rather than hanging in the case of a horizontal frame that is oriented to provide light in the upward direction), or may include a substantially non-vertical orientation such as a substantially horizontal orientation as the component chassis remains attached to the frame of a wall-mounted LED luminaire, for example. In general, the “different orientation” may involve an angle between the plane of the frame and the plane of the substrate of the component chassis of at least 10, 15, or 20 degrees such as from 20 degrees to 160 degrees, from 30 degrees to 120 degrees, from 45 degrees to 120 degrees, from 60 degrees to 100 degrees, from 75 degrees to 110 degrees, or about 90 degrees.

The different orientation is typically understood to be a temporary state as the component chassis is temporarily “opened” or made accessible while still being attached to the frame and, if desired, to the power source such as AC line voltage. In such cases, the one or more first engaging elements attached to or extending from or near the first side of the component chassis provide a connection to the frame, and particularly connect with the frame at or near the one or more openings of the first edge of the recess of the frame without aid from the one or more second engaging elements. The one or more openings in the first edge of the recess of the frame may simply function as a slot or other opening to receive engaging tabs or the like, or may have a shape such as a T-shape adapted to securely hold the wider cross-beam of a T-shaped engaging element. The solid walls around the one or more openings may also have a curved or angular lip or a ledge to further interact with curvature or other structural features of the one or more first or second engaging elements of the component chassis to ensure that the component chassis is securely held on place. The one or more openings of the first edge of the recess of the frame in particular may be adapted through mechanical interlocking or related methods such that the component chassis may be securely held in place by the one or more first engaging elements associated with the first side of the component chassis while hanging from the frame without the aid of the one or more second engaging elements on another side of the component chassis (or, more generally, when the second engaging elements are not connected to the frame but are rotated away from the frame). While hanging, components may be easily removed from and added to either side of the component chassis such as an LED driver or strips of LED lights

In some aspects, the component chassis may rotate about its first edge or about a line proximate the first edge of the component chassis, rotating relative to the frame or its plane, defining for example an approximately 90-degree angle (e.g., from 30 degrees to 120 degrees) between a first orientation in the fully connected state (a state with connections from both the first edge of the component chassis and connections along at least one other edge of the component chassis such as a second edge opposing the first edge of the component chassis) and a second orientation in a partially connected state, wherein the component chassis is held in place only along the first edge thereof, or defining any of the previously mentioned ranges of angles.

In some aspects, the frame itself can be held in place with frame engaging elements on opposing sides that attach to mounting brackets or other mounting fixtures, wherein the frame can be released from one side and allowed to swing down or otherwise rotate about the opposing side that remains connected with rotatable engaging elements. Such frame engaging elements may include one or more projecting elements such as a screw head adapted to engage with one or more slots in the mounting fixtures, which may serve as pivot points to allow the frame to swing up or down as it rotates about the projecting elements while secured in a slot or track. In such a case, when the other end of the frame is brought up into contact with the fixtures for securing the frame, the fixtures may have, for example, pins or other elements about which a corresponding rotating latch on one or more sides of the frame may engage. Closing the rotating latch may then firmly secure the frame in place against the fixtures in a ceiling mount or other mounting system. The combination of a static projecting element engaging with a slot and a remote movable or rotating element engaging with a structure in the fixtures provides a system for securing the frame while also allowing it to rotate substantially (e.g., up to 90 degree or more) relative to the fixtures and, for example, the ceiling or wall it is being attached to. This can also simplify installation, removal, repair, and the like.

Thus, in installing the frame, one or more rigid engaging elements on one end of the frame (e.g., on opposing sides at an end of the frame) may provide a connection to an opening in a fixture or suspending structure, and allow the frame to be rotated about that end to bring the opposing end into place in the ceiling or other structure receiving the frame, such that the opposing side of the frame can be fixed in place as one or more movable frame engaging elements are moved to secure the opposing edge of the frame. The one or movable frame engaging elements may include, for example, a rotating latch that encircles a pin to lock the frame into place, a sliding latch or lock, hook and loop connections (which generally require some degree of motion to make the connection firmly), tab and groove connections, etc. Screws, bolts, snaps, hooks, and the like may be used as well.

The modular system described here overcomes several common problems, such as the difficulty of replacing a defective LED drivers. In many prior cases, they are too difficult to remove and removing can easily result in damage to luminaire it is connected to even if sufficient access can be gained to the luminaire to attempt removal. Expert electrician help may be needed for such an attempt. The modular system makes upgrading the component chassis a simple process. With an easy-to-remove component chassis, a new component chassis can be received and easily installed as the old one is returned. The old unit is then quickly broken down and upgraded without the need to damage to the hardware to replace any modular components. Components that cannot be reused or repaired can be ground down into recyclable materials that can be reused, while other components are recycled and used again on component chassis that may have replacement LED drivers and other components as needed.

In some aspects, the amount of wiring used is reduced to simplify recycling and repair an improve sustainability. For example, instead of LED strips being daisy chained with wires as alternating ends of the power strips, wherein the wires are not only wasteful but can cast shadows onto the lens of the luminaire, the LED strips may be connected with a single distributor board that joins all LED strips in a luminaire via solder joins or other connections to the LED strips. The reduced wire and simplified structure can make it easier to replace an LED strip.

### Mechanical Interlocking

In general, for the connection of the component chassis to the frame as well as the connection of the frame to the receiving stricture, typically via various fixtures, one or more the engaging elements or other attaching devices may employ mechanical interlocking, particularly via geometric locking. The principle of mechanical interlocking may involve steric hindrance or geometrical interlocking as the shapes of the connectors interact with corresponding receiving slots or receptacles to secure the component chassis or frame in place and prevent unintentional disconnection. At the same time, the receiving slot can provide for easy disengagement when a specific motion or action is performed, such as lifting a T-shaped engaging element out of the lower slot of a T-shaped opening to allow the broader beam of the engaging element to reach the broad top of the T-shaped opening for easy removal.

The T-shaped connector may also integrate an L-shape, such that an L-shape is apparent when viewed from a side while the T-shape is evidence when viewed from the front or at an angle normal to the view showing the L-shape. Such a connector may have a rail or beam defining the lower part of the T-shape, and then a broader element that may extend out of the plane of the rail or beam to serve as a catch element for engaging the material of the frame such as the material defining the shape of an opening that receives the T-shaped connector. When the broader element is resting against a surface such as the edge of a slot or other opening in the frame of an LED luminaire, for example, the connector cannot be removed from the frame by pulling the connector away in a direction parallel to the plane of the lower body of the connector because the upper body of the connector will not be able to pass through the narrow lower leg of the T-slot due to steric hindrance, and even when raised to reach the upper opening of the T-slot, the bent or normally projecting orientation of the upper portion of the T-connector will prevent sliding out of the upper portion of the T-slot unless the connector is further raised to prevent the bent portion of the connector from catching on the edge of the upper slot.

Any variant of T-slot and T-connectors may be used, including V-slot rails, etc. Other examples of mechanical interlocking that may be considered include a keyhole mechanism with a keyhole slot, in which a circular connector with an attached shaft can be inserted into a larger circular opening of the keyhole slot and then slid into a narrower slot, locking it in place. Also to be considered is a bayonet mount in which a component with pins engages with a slot; dovetail joints in which a trapezoidal pin on one piece fits into corresponding slots on another piece; mortise and tenon connections; barrel locks that form a pivotable connection; etc.

Also to be considered is a simple connector such as an L-shape or other suitable shapes, including use in conjunction with a simple slot such as a rectangular slot in the connecting surface (e.g., in the recess of the frame or in a fixture for holding the frame). While an L-shape could be used with a simple rectangular slot, when rotated 90 degrees, the base or foot of the “L” would be resting on the edge of the slot and could be at risk of falling out. This risk could be reduced by replacing the lip with a 90-degree angle with a lip at a more acute angle, such as from 30 to 80 degrees, to give an “acute L” shape similar to the top of the numeral “1” (when written with a descending line or serif). The acute angle of the lip maybe formed by a straight line, but a similar catch can be obtained using a curled lip, a curved hook-like shape (similar to a shepherd's staff), etc. The engaging element may also have a pin or 90-degree protrusion for engaging a slot when in a horizontal position, and a further lip at an acute angle so hold the engaging element in place when it is rotated relative to the slot. Thus, “acute L” shape may provide a lip to engage a simple rectangular slot and to allow substantial rotation about the slot while still maintain a reliable connection.

Thus, an acute angle connector may be employed with an engaging element that may be substantially rectangular or planar apart from the acute angled element, or may be curved, T-shaped from a first perspective but L-shaped or acute-L shaped from a second perspective, etc. The angled portion of the cute angle connector may serve as a lip in which the tip of the descending angled portion engages the surface adjacent an opening to hold the connector in place relative to the opening, while when the connector is rotated to a different orientation such as from horizontal to vertical, the cusp of the acute angle connector engages with the material at the edge of the slot to hold the connector in place.

An acute angle connector or L-shape connector or simple projection from a connector surface may be used for either or both of the first and second engaging elements of the component chassis. For example, a movable engaging element with, say, a sliding or rotating motion being used to secure the connection, may have an acute angle for engaging the edge of a slot. In some aspects, such an acute angle could also permit the one or more second engaging elements to secure the component chassis without the aid of the one or more first engaging elements, if desired, thereby making it possible to “open” the component chassis for upgrades, repairs, etc., by having it hang securely from either side, as desired.

In some aspects, the angle of the acute angle connector or geometry in general of the engaging elements may be adjustable to optimize performance for the product or desires of the user. Thus, an engaging element may feature a mechanism to adjust the angle of the angle connector. In other aspects, adjustment of the connectors may be made by adjusting the height of a screw or bolt that may serve as a lip or catch. Adjustment may also be made in the materials of the engaging elements, which may be customizable by adding materials such as adhesive patches that provide rubberized materials for increased friction in a slot, etc. Locking mechanisms may also be added to reduce the risk of unwanted or unauthorized release of the component chassis or of the frame. Thus, a clip or latch may be used, etc.

### Movable Engaging Elements

In some aspects, the component chassis includes one or more engaging elements on a first side of the component chassis and one or more movable engaging elements on at least one other side of the component chassis such as an opposing side, wherein the movable engaging elements may include a sliding lock, a rotating hinge, a locking lever, and the like.

Thus, in some aspects, a securing mechanism is provided for securing one side of the component chassis with one or more movable engaging elements, wherein the securing mechanism may include, for example, a rotatable latch or tongue, operationally connected to a knob or handle situated on the component chassis surface. In a default position, the latch or tongue may remain retracted, allowing for easy placement or removal of the component chassis. Upon rotation of the knob or handle, such as through a 90-degree turn, the latch or tongue extends outwardly, engaging a corresponding groove or recess located on the frame or adjacent structure. This groove or recess may be adapted to receive and securely hold the extended latch or tongue, thereby locking the component chassis in place.

The groove or recess may feature a shape complementary to the latch or tongue, ensuring a snug fit when the latch is extended. Such a design can provide both a secure connection and a quick-release mechanism, as a simple rotation of the knob or handle retracts the latch or tongue, freeing the component chassis for adjustments or removal.

Furthermore, the knob or handle may incorporate tactile or visual indicators to signify the latch's position.

In one aspect, the latch or tongue may feature a cam-like design, wherein the rotation of the knob or handle causes a linear movement of the latch, driving it into or out of the groove or recess. This cam action provides a robust and secure locking mechanism, resistant to unintentional disengagement.

In another aspect, the groove or recess may incorporate a spring-loaded catch or detent, providing an additional layer of security by resisting unintentional rotation of the knob or handle, thereby preventing accidental release of the component chassis.

In general, the one or more movable engaging elements of the component chassis may be adapted to engage with one or more corresponding openings located on the frame, such as along one edge of the recessed portion of the frame opposite from the first edge of the recessed portion of the frame. This engagement mechanism may aid in the stabilization and retention of the component chassis. Upon full elevation of the component chassis against the frame and the establishment of the necessary electrical connections, a movable securing mechanism including the movable engaging elements, such as a sliding lock present on the component chassis, is activated to secure the component chassis in place. This mechanism, in conjunction with the protruding elements, can ensure the component chassis' secure attachment to the frame.

For maintenance or repair purposes, the movable securing mechanism can be disengaged, allowing the component chassis to pivot around the edge where the protruding engaging elements are inserted into one or more openings of the frame. This pivotal movement may permit a 90-degree rotation relative to the attached edge, facilitated by the specific design of the protruding engaging elements, ensuring continued engagement with the frame's openings during rotation.

In another aspect, the movable securing mechanism is a slide lock positioned centrally on the panel's side opposite the protruding engaging elements. This slide lock engages with a corresponding slot on the frame, providing an additional layer of security. When engaged, the slide lock prevents any unintentional dislodgment of the central panel. However, when disengaged, it allows the central panel to pivot around the L-shaped hooks or other engaging elements for easy access during repairs.

Further, the frame's openings can be reinforced with metal or durable plastic to ensure longevity and reduce wear over time. These aspects provide a robust and user-friendly design, ensuring easy maintenance without compromising the apparatus's structural integrity.

In another aspect, the connection between either the first engaging elements or the second engaging elements and the frame can also be made with a hinge element having a slidable pin or bolt joining aligned tubular units to form a hinge such as a barrel hinge that can rotate about the pin or bolt that passes through the tubular units. In one aspect, a spring-loaded barrel hinge could have the pin or bolt held in place by a spring that could be pulled out to disconnect the barrel hinge to disconnect an engaging element, and then this could be readily reconnected.

In another aspect, the component chassis need not rotate 90 degrees relative to the frame, but could rotate a smaller extent such as 45 degrees or less or 35 degrees or less, with the degree of rotation constrained by a cable. In such aspects, the first engaging element can be relatively simple such as tabs engaging with a slot in the frame or a downward lip on the edge of the component chassis that engages with an upward lip on a shelf or ledge extending from the frame. In such aspects, the second engaging elements need not be slidable or rotatable, but could be based on magnets that join the second edge of the component chassis to the frame, for example. In related aspects, the rotation need not about a long edge of the component chassis, but could be about a short edge with the length of the component chassis able to rotate about the short edge. Again, a cable may be in place between the frame the component chassis to constrain the degree of rotation while allowing the component chassis to be moved to an orientation that is open enough to make treatments to the back side of the component chassis (e.g., at an angle of at least 10, 15, 20, 25, or 30 degrees relative to the “closed” position or to the plane of the frame).

Such a cable could be easily installed using a T-bar mechanism or a toggle hanger such as a Gripple toggle hanger or aircraft cable hanger. It may be fixedly attached at one end to the component chassis, for example, but removably attachable via the toggle hanger to the frame such as the rear surface of the recess of the frame. In the toggle hanger mechanism, a cross-beam threaded on a cable with a stop is aligned with the cable and inserted through a narrow opening in the frame it is being attached to, and then the cross-beam is held laterally in place on the frame. Removing the connection requires pushing the cable up and threading an end of the cross bream back into the slit or hole to pull the beam and the cable out.

### Further Details

A server such as one in or associated with the command center may be used for tracking stored LED items that have been received for refurbishing and may be in a repository, workshop, etc., awaiting final preparation and shipment to a customer. Software associated with the command center or with the server that manages LED inventory and items that have been received or have been reported as in need of replacement, can be used to assign a stocked resource or an incoming resource (an item that will soon be received by a service provider). The server may provide an interface in the form of an app, a website, a computer program, an AI tool, etc. When a service request from a customer is received, the software may take several steps illustrated by the following exemplary program or method:
(1) The service request is first checked to determine if can be fulfilled in full or in part using available refurbished materials in the repository or other locations that were previously used by the customer or their subsidiaries. If so, the materials are retrieved and examined to confirm suitability. If not, available refurbished materials from other customers are checked to see if they are available for use in fulfilling the service request. If insufficient inventor exists, then new LED components may need to be used instead. These options may be discussed with the customer to allow them to make an informed decision in light of sustainability factors but also costs and time. The materials needed to full the service request are then gathered.
(2) All components are processed if needed to ensure that they comply with the current service request. This may require removing some components such as an LED driver, or replacing a module therein, or adding components not currently on the component chassis such as a sensor, backup batter unit, colored lighting functionality instead of white only.
(3) The processed components are tested for quality and compatibility with the service request. Inadequate units may be returned to a repository for future use or removed from the supply chain by recycling the useful materials therein.
(5) The UIDs of LED components, especially those of the component chassis, are scanned to indicate that a shipment is being prepared. Databases are updated to reflect the processing and other changes that have occurred.
(6) Initial sustainability calculations may be made and reported or stored showing the energy use, water use, air pollution, and carbon emissions reductions that have occurred by virtue of providing refurbished items instead of new items, including net-zero benefits and credits for upcycling one's previously purchased items. The results may be shared with the client for incorporation into sustainability reports or other reports, tax credit applications, etc.
(7) The items are then packaged using, when possible, minimal packaging materials, fiber-based or plant-based or post-production materials, with space-conservation principles to reduce sustainability impact by having multiple items in one package. The items are then shipped to the customer. Efficiency gains of 30% or more relative to conventions LED luminaires can be achieved and contribute to the sustainability analysis of step (6).
(8) Upon receipt, the customer or party recommended or provided by the service provider complete installation of the shipped components, typically without the need for an electrician. Each item as it is being installed or afterwards should be scanned with a suitable scanner that can communicate with the command center and its servers to ensure that the geophysical location of each unit is stored with other updated data pertinent to maintenance, service life, and sustainability of the system.

The method or program above can be implemented in an app that guides the customer through the steps of making a service request, shipping materials, installing materials, and provides insights into sustainability issues and reported data.

A relational database management system (RDBMS) may be selected, for example, to support complex queries and ensures data integrity. An RDBMS like PostgreSQL, which includes PostGIS for geospatial data, may be used, for example. Tables in this database could include locations, usage data, refurbishment status, and inventory levels.

For handling large and growing volumes of unstructured or semi-structured data from expanding LED operations, a NoSQL database like MongoDB, which supports JSON-like documents, could be used in order. MongoDB's geospatial indexing and querying features could also be of use, for example.

A combination of both relational and NoSQL databases may ale be considered, such as RDBMS for transactional data and a NoSQL database for high-volume, flexible data storage and rapid querying.

### BRIEF DESCRIPTION OF THE FIGURES

FIG. 1 depicts a schematic of the entities that may be involved in transactions in which a component chassis of an LED light is found to be in need of repair or an upgrade.

FIG. 2 depicts a flow chart showing how previously retuned LED components can be upgraded or repaired and returned to the customer when there is a need.

FIG. 3 depicts a cross-section of a modular LED luminaire.

FIG. 4 depicts the cross-section of the LED luminaire of FIG. 3 after the component chassis has been rotated relative to the frame, but still attached by the first engaging elements.

FIG. 5 depicts a perspective view of a portion of the frame of an LED luminaire.

FIG. 6 depicts the back side of an LED component chassis.

FIG. 7 depicts a view of a first engaging element of a component chassis engaged with the wall of a recess of the frame of an LED luminaire.

FIGS. 8A and 8B depict views of a first engaging element in different orientations interacting with the wall of a frame.

FIG. 9 depicts a front view of one aspect of a component chassis.

FIG. 10 depicts a stack of frames each without a component chassis.

FIG. 11 depicts a component chassis fully connected to a frame.

FIG. 12 shows a photograph of a component chassis.

FIG. 13 is a photograph of a box containing a set of component chassis with a nested stack of lenses.

FIG. 14 is a photograph showing a box adapted to contain the components of complete LED luminaires.

FIG. 15 is a flow diagram of a computer-assisted LED management process that builds on the LED management system of FIG. 1.

### DETAILED DESCRIPTION

Further details are now described with respect to the figures.

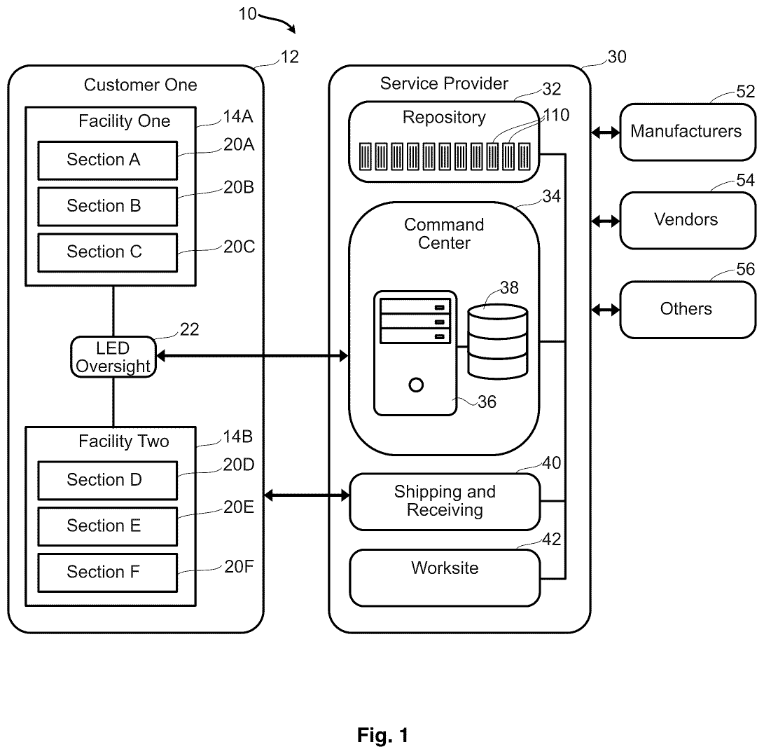

FIG. 1 depicts an LED management system 10 for implementing an LED

management method. In this LED management system 10, a service provider 30 (e.g., a vendor, manufacturer, or authorized representative), can apply data tracked in the command center. The service provider 30 may be in partnership with one or more manufacturers 52, one or more vendors 54 who may sell LED lighting materials (not shown), and others 54 such as regulators, energy efficiency agencies, environmental groups etc. In some aspects, the service provider may be a part of or otherwise owned or controlled by a manufacturer or two or more manufacturers in collaboration. The service provider 30 also has a relationship with Customer One 12 and any other number of customers (not shown).

Customer One owns Facility One 14A, having Sections A 20A, B 20B, and C 20C, where LED lights from one of the manufacturers 52 may have been installed. Customer One 12 also owns Facility Two 14B with Sections D 20D, E 20E, and F 20F, each also having LED lights from one of the manufacturers 52. The LED lights may have been purchased through one of the vendors 54 or directly from one of the manufacturers 52.

In the depicted LED management system 10, Customer One 12 has an LED Oversight function 22 which administers the LED lighting. This may involve one or more humans in the LED Oversight function 22, or may be a highly automated process in which a processor and a server process data about LED lights in Facility One 14A and Facility Two 14B (for example) and determine when a repair or upgrade is needed (e.g., though monitoring LED driver status or light output), typically in conjunction with human approval to provide further oversight or human control to manage awareness of potential upgrades and their priority. Whether automated, performed by humans, or in some combination thereof, the LED Oversight function 22 communicates with the service provider 30 (e.g., electronically, by voice, etc.) and requests repair or upgrade of a portion of the LED lights in the facilities 14A, 14B of Customer One.

The service provider has a repository 32 in which previously returned component chassis 110 from Customer One 12 are maintained in storage until needed later, either by Customer One only or optionally also by other customers (not shown) with similar lighting systems. Entire LED luminaires (not shown) may also be stored, if needed, though in many cases only the component chassis 110 may need to be upgraded, repaired, or stored in the repository 32. Thus, when Customer One 12 wishes to return, say, ten component chassis 110 to receive an added feature or upgrade of some kind, a service request can be issued from the LED Oversight function 22 requesting ten refurbished component chassis 110. A database 38 in communication with a server 36 in a command center 34 of the service provider 30 can then be accessed to confirm that the desired number of previously used component chassis 110 from Customer One 12 are present in the repository 32, and their locations can then be determined to facilitate retrieval, or retrieval can be executed automatically. The server 36 may in practice comprise more than one computer systems in communication, with each server or computer system also comprising or being in electronic communication with a processor (not shown) and suitable software in any useful form and medium.

The identified component chassis 110 from Customer One 12 may then be brought to the worksite 42 (which may be part of or adjacent to or near the repository 32 or any other desired location) where they can be upgraded or repaired, if needed, and tested prior to shipping them to Customer One 12 via shipping and receiving 40. Messages can then be sent from the command center 34 to Customer One 12, such as to the LED Oversight function, giving notification of the shipment, the status, if desired (e.g., test results confirming performance), and the estimated data of arrival, and a request for shipment back to the service provider of the units being replaced, so that those component chassis can also be entered into the repository 32 for storage and further processing as needed, to eliminate the waste that might have otherwise happened with the unwanted prior units (the ten component chassis 110 in this case).

The command center 34 may be a largely automated function that receives data from customers (e.g. Customer One 12), sends communications, directs the flow of materials from the repository 32 to the worksite 42 with instructions for processing and testing, directs flow of finished products from the worksite to shipping and receiving 40 with instructions for shipping and instructions for receiving units being shipped to the service provider 30, receives confirmation upon receipt of shipped goods by customers, and also interacts with manufacturers 52 or vendors 54 to order needed supplies for the worksite 42 including reserve component chassis 110 or entire LED luminaires (not shown) in case some units returned by customers are not suitable for upgrading or repair. The command center 34 may also interact with others such as regulators environmental agencies, licensing partners, etc., to ensure that proper steps are taken with respect to various external requirements that may need documentation or details of transactions for various purposes. Many of these operations may be AI-assisted.

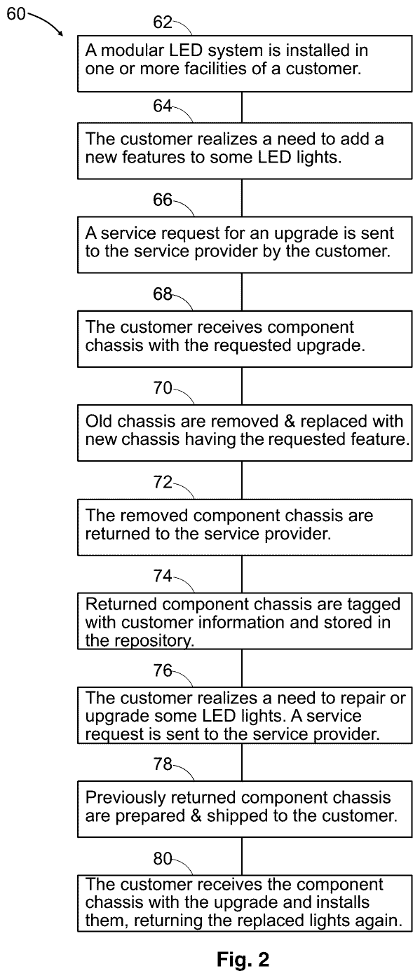

FIG. 2 depicts the workflow 60 in an example of a new customer of the service provider 30 interacting with the service provider over time. In step 62 occurring at the beginning of the workflow, a modular LED system is installed in one or more facilities of a customer. The modular LED system has, for example, a component chassis that can readily be separated from the frame of an LED luminaire without the need for tools or shutting down an entire power circuit and readily replaced with a similar upgraded component chassis. In general, the component chassis of the modular LED system has a first set of characteristics (LED driver type, type of LED lights, connector type, auxiliary devices such as sensor, etc.).

In step 64, the customer later realizes a need to add a new features to some LED lights. This could be, for example, due to a goal of integrating the LED luminaires into a school safety system in which LED luminaires are equipped with sensors such as microphones for gunshot detection, motion detectors or cameras, heat trackers, WIFI systems, etc. Alternatively, a component in the component chassis may need replacement. As a result, in step 66, a service request for an upgrade is sent to the service provider. The service request may ask for component chassis having a second set of characteristics.

In step 68, the customer receives one or more component chassis with the requested upgrade, sent by the service provider. Since there may be no suitable used component chassis in the repository for this customer, the component chassis sent may be new, unused component chassis, or could be excess previously used component chassis from a prior customer. In any case, the service provider prepares the requested component chassis for the customer, ensuring that they have the requested second set of characteristics, and sends them to the customer according to step 68. Thereafter, in step 70, the old component chassis are removed and replaced with the new (or refurbished if available) component chassis having the requested feature, the second set of characteristics. Then in step 72, the removed (and replaced) component chassis are returned to the service provider. In step 74, the returned component chassis received by the service provider are tagged with customer information (identity, date received, set of characteristics, reason for the exchange, etc.) and stored in the repository. The location in the repository can also be recorded and associated with the database. Tagging may include adding a label or mark to the back of the component chassis identifying its location, serving also as an identifier in a database of received component chassis. Tagging may also be done by scanning a bar code, QR code, or other identifier on the component chassis, or manually recording a serial number or other code, and entering that information into a database for received component chassis. Scanned images and photos of the component chassis before and after any upgrades may also be associated with a database of component chassis.

In step 76, at a still later time, the customer realizes a need to repair or upgrade some LED lights. Therefore, a service request is sent to the service provider asking for a number of component chassis with a particular set of characteristics, which may be a third set of characteristics different from the second set of characteristics and may also be different from the original first set of characteristics.

In step 78, the previously returned component chassis are prepared with the desired characteristics (e.g., a third set of characteristics or more of the second or first set of characteristics if desired) and shipped to the customer. In step 80, the customer receives the component chassis with requested upgrade and installs them, returning the replaced lights again to the service provider.

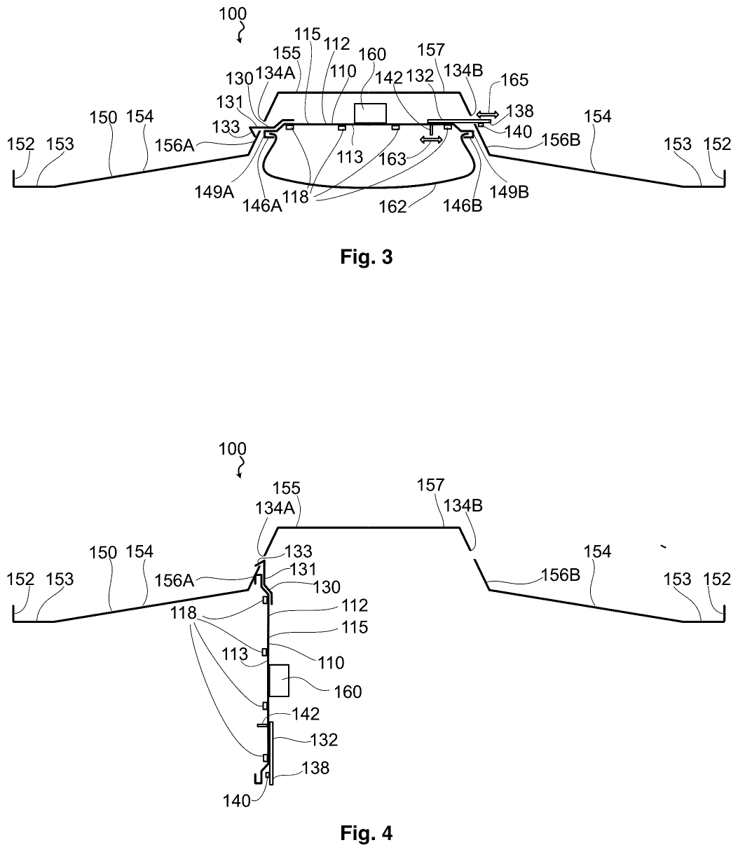

FIG. 3 depicts a cross-section of an LED luminaire 100 having a component chassis 110 comprising a substrate 112 and having a front side 113 and a back side 115. The LED luminaire 100 further comprises a frame 150 having an outer edge 152 which can be used to attach to fixtures (not shown) associated with a suspension ceiling, fixed ceiling, wall, or other surfaces (not shown). The frame 150 may be made of sheet metal, composite materials, plastics, and the like, and further comprise a flat outer surface 153, a sloped reflector region 154, a recess 155 having a first edge 156A, and opposing second edge 156B, and a rear surface 157, wherein the recess 155 is adapted to receive the component chassis 110 (in some aspects, the rear surface 157 may be open in portions of the frame 150 or may be absent, and in some aspects the first edge 156A and second edge 156B may be substantially shorter than shown here). The first edge 156A of the recess 155 has a first opening 134A (only one first opening 134A is visible in this cross-section, but it should be understood that two or more first openings 134A may be provided in the first edge 156A of the recess 155 along the length of the first edge 156A normal to the plane of the drawing) and the second edge 156B of the recess 155 has a second opening 134B (again, only one is shown but two or more second openings 134B may be present along the length of the second edge 156B normal to the plane of the drawing). The first opening 134A is adapted to receive a first engaging element 130 that is attached to the component chassis 110, while the second opening 134B is adapted to receive a second engaging element 132 that is also attached to the component chassis 110. In some aspects, the first engaging element 130 and the second engaging element 132 can be substantially similar and operate by the same method, but as depicted the two are different, with the first engaging element 130 being substantially static while the second engaging element has a movable mechanism. The first engaging element 130 has a rigid structure 131 mounted to the component chassis 110 (e.g., to the substrate 112) which extends outward past a first edge 149A of the component chassis 110 and into the first opening 134A of the recess 155. At the end of the rigid structure 131, which may be a flat plate, a ribbed or reinforced plat, a rectangular bar or beam, etc., a catch element 133 is present which as shown bends downward to form a lip or catch that can engage the frame 150 surrounding the first opening 134A to hold the rigid structure 131 and the associated component chassis 110 in place with respect to the frame 150. The catch element 133 may form an acute angle with the rigid structure 131, but may also be curved such as a curled lip or hook-like structure (not shown).

The second engaging element 132 is similarly adapted to engage with the second opening 134B in the second edge 156B of the recess 155 and to be restrained by the material of the frame 150 adjacent the second opening 134B. Here, however, the second engaging element 132 is movable, having a movable plate 138 that can be moved manually by moving an attached pin 142 that projects through an opening (not shown) in the substrate 112. The range of motion as shown by first arrows 163 is a short distance from right to left (sideways) as depicted, capable of moving the movable plate 138 into or away from the second opening 134B, as shown by second arrows 165.

Here the movable plate 138 is slightly higher than the rigid structure 131 that extended into the first opening 134A, and thus the second opening 134B as shown is slightly higher than the first opening 134A (e.g., at least 1 cm higher, such as from 1 to 10 cm or from 2 to 7 cm) due to its attachment to the relatively more elevated body of the component chassis 110 rather than extending from a lower surface of the component chassis 110 as shown for the first engaging element 130.

The outer edge of the movable plate 138 may have a projection 140 that can serve as a lip or stop to prevent accidental release of the second engaging element 132 from engagement with the frame 150 at the second opening 134B of the second edge 156B of the recess 155 of the frame 150. The projection 140 may be a screw, a rubber foot or stopper, a plastic or metal pin, a component stamped or cut from the material of the movable plate 138, etc. The presence of the projection 140 may require lifting of the component chassis 110 to make it possible to slide the movable plate 138 away from the frame 150.

The first edge 149A of the component chassis 110 may define a first channel 146A such as a linear channel adapted to receive an edge of a lens 162 that can be held in place over the component chassis 110. The second edge 149B of the component chassis 110 may further define a second channel 146B for receiving an opposing edge of the lens 162, with the first channel 146A and the second channel 146B cooperating to hold the lens in a desired configuration.

Not shown on the component chassis 110 is a receptacle to receive power from a power line (also not shown), sensors such as motion detectors that may be adapted to function through the lens 162, radios such as Bluetooth or WIFI systems, wattage and color adjustment systems to control the appearance of the LED lights 118, etc.

FIG. 4 depicts a the cross-section of the LED luminaire 100 of FIG. 3 wherein the lens 162 has been removed and the second engaging element 132 has been detached from the frame 150 while the first engaging element 130 remains connected to the frame 150, followed by rotating the component chassis 110 relative to the frame 150 such that the second engaging element 132 has been moved to be remote from the frame 150 and from the second opening 134B in the recess 155. In this configuration, the component chassis 110 is “open” such that the back side 115 of the component chassis 110 (or of the substrate 112) with components such as the LED driver 160 are accessible for repair, adjustment of settings, replacement, upgrading, or adding new components (not shown) such as a motion detector, camera, microphone, radio, etc. after the component chassis 110 has been rotated relative to the frame 150, but still attached by the first engaging element 130. In some aspects, this can be done without removing the connection to the line power (not shown) that provided power to the LED driver 160. For example, to adjust the settings of wattage or color of the LED lights 118, a simple sliding switch of adjustment box (not shown) may be adjusted with the component chassis 110 in an open position without the need to disconnect power. Further, if the component chassis 110 itself needs to be replaced, the connection to the power line (not shown) may be disconnected using a simple snap-on connection or other connection, and then the component chassis 110 may be lifted away from the frame 150 and a new component chassis 110 can then be hung in place using its first engaging elements 130 attached to the first opening 134A of the recess 155 of the frame 150, and then the power line may be connected to the LED driver 160, and then the component chassis 110 may be rotated upward to bring the second engaging elements 132 proximate to the second openings 134B of the recess 155, and then the pin 142 can be moved manually to position the movable plate 138 into the second opening 134B of the second edge 156B of the recess 155 of the frame 150 to secure the component chassis 110 securely in contact with the frame 150.

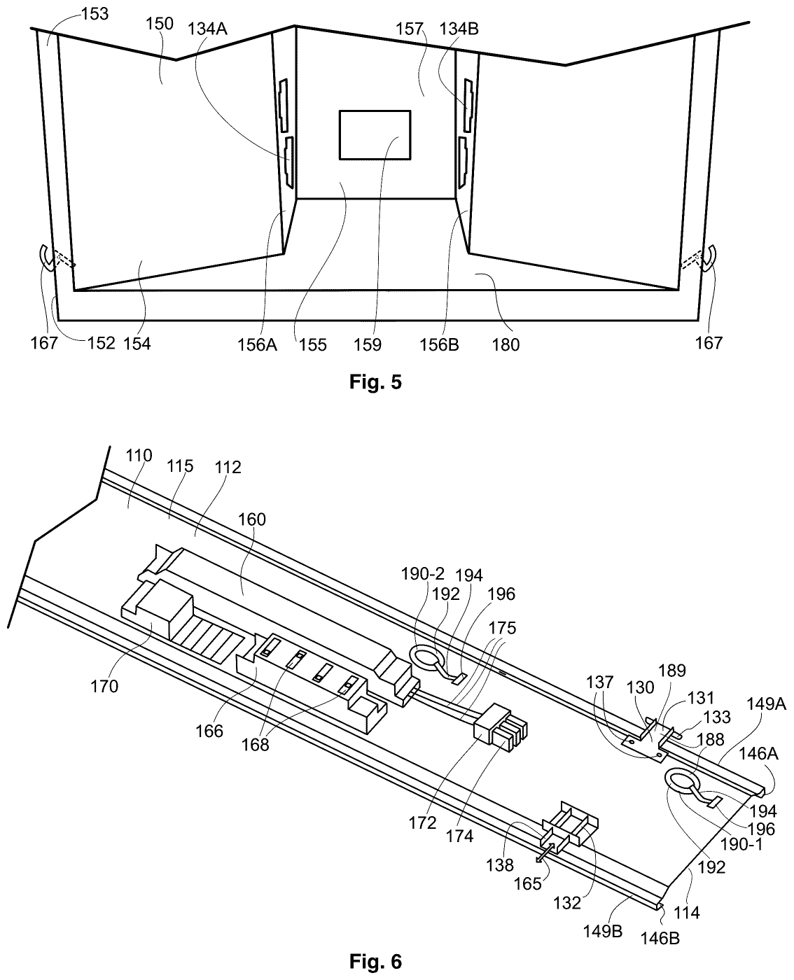

FIG. 5 depicts a perspective view of a portion of a frame 150 having an outer edge 152, a flat outer surface 153, a sloped reflector region 154, a recess 155 having a first edge 156A, a second edge 156B, and a rear surface 157 therebetween. Also shown on the opposing edges of the frame 150 are two rotating latches 167 which can connect the frame 150 to fixtures (not shown) in the mounting surface, which may have pins (not shown) which the two rotating latches 167 can engage when they are rotated into a closed position about the pins (not shown) or other suitable protrusions. Also shown is a first end 180 of the frame 150, a first opening 134A and an opposing second opening 134B in the recess 155, and rear opening 159 in the rear surface 157 of the recess 155 through which electrical connections maybe made between the LED driver (not shown) of the component chassis (not shown) that can be secured to the frame 150 via engaging elements (not shown) interacting with the first opening 134A and the second opening 134B.

FIG. 6 depicts the back side 115 of a component chassis 110 showing the substrate 112, the LED driver 160, a modular adapter 170 for receiving devices such as a radio or sensor (not shown), and a switching block 166 comprising a plurality of switches 168, here shown as slidable switches, for setting parameters for the LED driver 160 (e.g., color, wattage, etc.) or other components. Also shown are wires 175 connecting the LED driver 160 to a receptacle 172 with multiple connectors 174 for connecting to a power line (not shown). A first end 114 of the component chassis 110 is in view also.

A first engaging element 130 and a second engaging element 132 are shown on opposing sides of the component chassis 110. The first engaging element 130 has a movable plate 138 with direction of motion indicated by arrows 165. The first engaging element 130 is adapted to remain connected to the frame 150 (not shown) when the second engaging element 132 is disconnected from the frame 150 (not shown), allowing the second edge 149B of the component chassis 110 to move out of the plane of the frame 150 to make the backside 115 of the component chassis 110 readily accessible to a worker without the need for tools or the need to use one or both hands to hold the component chassis 110 in place when accessing components thereon.

An alternate form of connecting the component chassis 110 to a frame 150 (not shown) is also contemplated in which a two-part first engaging element 188 is shown in which the first engaging element 130 serves as the first part 189 of the two-part first engaging element 188 with a second part 190-1 also present, shown as a ring 192 joined to a tether or flexible band or cable 194 and secured to the substrate 112 by an anchor 196. Another second part 190-2 is also depicted to indicate that the number of second parts 190 need not be the same as the number of first parts 189 of a two-part first engaging element 188.

When the component chassis 110 is being installed, detached, or partially detached, the first part 189 of the two-part first engaging element 188 can be disconnected from the frame 150 (not shown) and the second part 190-1 (and/or 190-2, for example) of the two-part first engaging element 188 can be used to connect to a suitable protrusion from the frame (not shown) such as a finger, a hook, a tab, a suitable oriented pin, etc., and the component chassis 110 thus secured (e.g., by two or more such second-parts 190-1 and 190-2, for example) can then hang from the frame (not shown) to expose the back of the component chassis 110 for treatment by a technician without the need to hold it by hand.

The second-part 190-1, 190-2 of a two-part first engaging element 188 also illustrates the ability of an engaging element to be flexible. In alternative forms, it may also be adjustable or tightenable such as by cinching or adjusting the flexible band or cable 194. In other aspects, the anchor 196 may also be on the front side (not shown) of the component chassis 110. I other aspects, the flexible band or cable 194 and ring 192 may be attached to the frame (not shown) and adapted to engage with a hook, finger, tab, etc. (not shown) on the component chassis 110, which can then serve as an engaging element to connect to the frame (not shown). The flexible band or cable 194 in some aspects can also be replaced with a rigid connector (not shown) such as a rod or beam, while it could also be a chain, rope, etc., and still employ related principles such as connecting a ring or other loop or hook with a suitable structure for retention, and in some aspects such structures may serve as a replacement for the one-part first engaging element 130, adapted for engagement in two or more orientations of the component chassis 110.

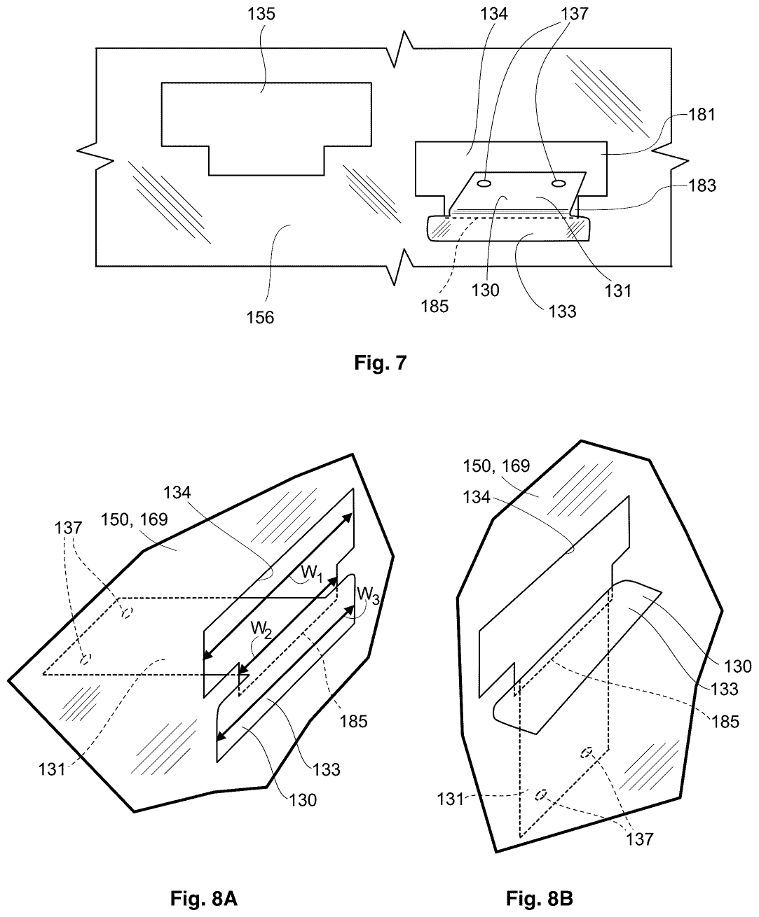

FIG. 7 provides a view of a first engaging element 130 having a rigid structure 131 and a catch element 133 attached to the rigid structure 131 defining both an L-shape from one perspective and a T-shape from another perspective. The first engaging element 130 is shown engaged with an opening 134, shown having a T-shape with a broad upper portion 181 and narrower lower portion 183 in an edge 156 of the recess 155 of the frame 150 (not shown). The rigid structure 131 of the first engaging element 130 extends into the opening 134, and the rigid material of the surrounding edge 156 of the recess 155 in the lower portion 183 of the opening 134. The rigid structure 131 lies on the lower edge 185 of the lower portion 183 of the opening 134. This mechanical interlock holds the component chassis 110 (not shown) in place related to the frame 150 (not shown) due to the restraint against the catch element 133 unless the rigid structure 131 and the catch element 133 are manually raised to allow the catch element 133 to pass through the broad upper portion 181 of the opening 134 to release the first engaging element 130 from the opening 134 of the recess 155.

FIGS. 8A and 8B depict the interaction of the first engaging element 130 with the wall material 169 of the frame 150 around the opening 134 of the first edge 156A of the recess 155 of the component chassis 110 (not shown). In FIG. 8A, the rigid structure 131 of the first engaging element 130 rests on the lower edge 185 of the T-shaped opening 134. The rigid structure 131 is connected to the component chassis 110 (not shown) by connections 137 that may be screws, welds, adhesive material, hook and loop connectors, etc. Descending or projecting out of the plane of the rigid structure 131 (e.g., projecting normal to or otherwise out of the plane of the rigid structure 131) is the catch element 133 which has a width W3 that is wider than the width W2 of the lower portion 183 of the opening 134 but less wide than the width W1 of the upper portion 181 of the opening 134, making it mechanically locked to prevent withdrawal from the opening 134 unless the catch element 133 is raised sufficiently to clear the lower portion 183 of the opening so that it can pass through the upper portion 181 of the opening 134.

In FIG. 8B, the elements of FIG. 8A are shown in a new relationship after the component chassis 110 (not shown) has been rotated 90 degrees relative to the wall material 169 of the frame 150, with the first engaging element 130 acting to hold the component chassis 110 to the frame 150. Now the catch element 133 extends normal to the place of the opening 134 as the rigid structure 131 extends downward. The catch element 133 still cannot be freed from the obstruction of the wall material 169 of the frame 150 because of steric hindrance, as the mechanical interlock defined by the geometry of the first engaging element 130 and the wall material 169 of the frame 150 prevents removal or dislodging of the first engaging element 130 from the frame 150 unless the catch element 133 is raised to reach the upper portion 181 of the opening 134 to allow it to pass through the opening 134.

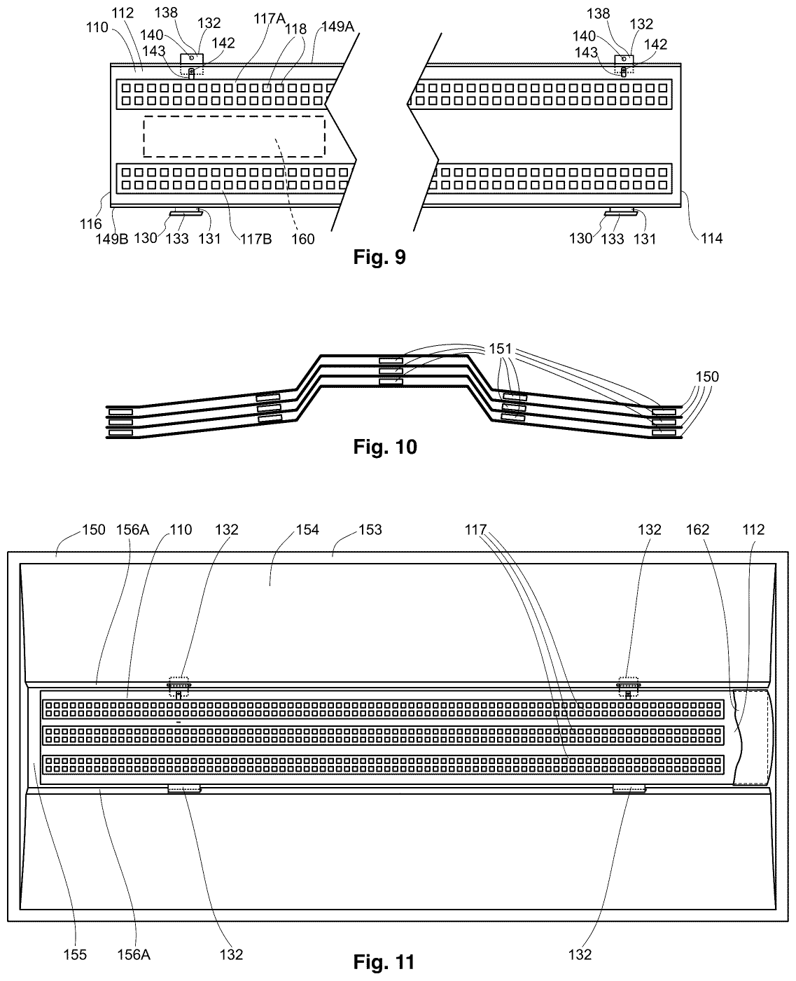

FIG. 9 depicts a front view of one aspect of a component chassis 110 showing two LED strips 117A, 117B. The component chassis 110 has a first end 114 and an opposing second end 116, and two opposing lateral sides or edges, a first edge 149A and a second edge 149B. The first edge 149A has two first engaging elements 130 projecting therefrom, each with a rigid structure 131 and a catch element 133, though other static or movable attachment units could be used instead. The second edge 149B as depicted holds two second engaging elements 132, each with a movable plate 138, a pin 142 for moving the movable plate 138, a pin 140 (a connector which can be a bolt, screw, pin, curved or bent element projecting from the movable plate 138, etc.) for connecting with or catching on the wall material 169 (not shown) around the second opening 134B of the frame 150 (not shown) by, for example, a mechanical interlock or steric hindrance.

FIG. 10 illustrates how multiple frames 150, when not holding the component chassis 110 (not shown), can be stacked together efficiently to reduce space and shipping materials. To prevent damage, the frames 150 may be held apart by thin pads 151 of a deformable or resilient and possibly recyclable material such as expanded polyethylene (EPE) foam, corrugated paper or other bulky paper materials, etc., which may cushion and protect the frames 150 from one another during handling. The pads 151 may be adhesively attached or put in place without adhesives in some cases. In some aspects, the pads are from 1 mm to 6 mm thick.

FIG. 11 depicts a component chassis 110 when fully connected to the frame 150, held securely in place by first engaging elements 130 and opposing second engaging elements 132. A portion of the lens 162 is shown over the component chassis 110. In this aspect of a component chassis 110, three LED strips 117 are shown.

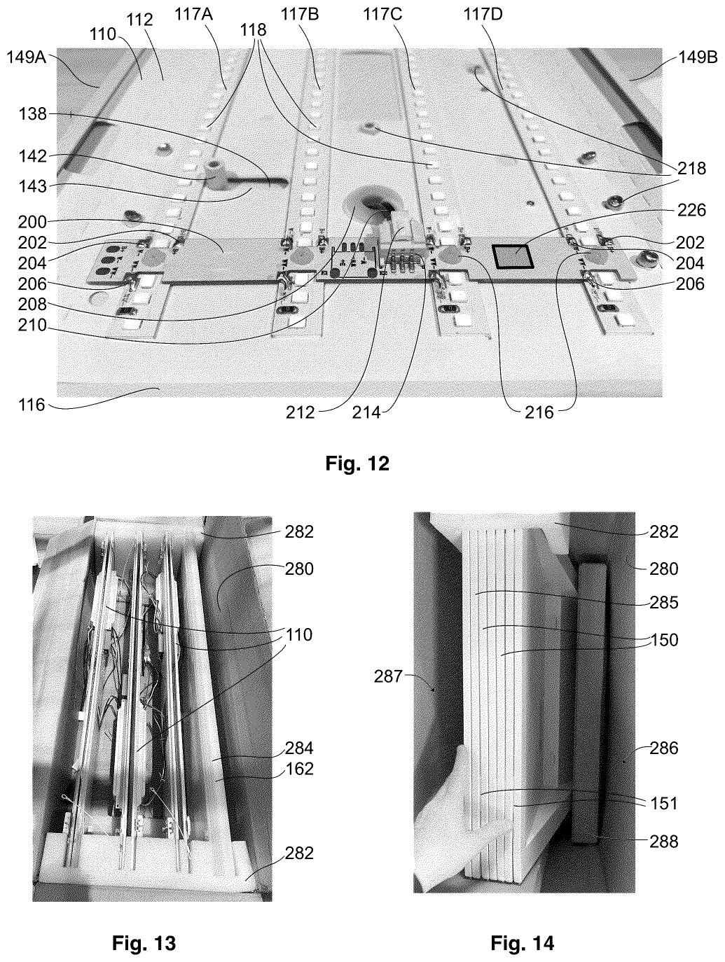

FIG. 12 shows an image of a component chassis 110 with four LED strips 117A, 117B, 117C, 117D each comprising a plurality of individual LED lights 118. Rather than using traditional wiring with connections joining alternating ends of adjacent LED strips one to another with numerous wire (not shown), a more sustainable approach shown here employs a distributor board 200 that connects to the LED driver 160 (not shown) via LED wires 210 (three are shown, though any suitable number of LED wires 210 may be used) reaching the front face of the component chassis 110 via an insulated aperture 208, wherein the LED wires 210 terminate in a quick connect connection 212 that plugs into a receptacle 214 on the distributor board 200. Screw-based connectors 216 join the distributor board 200 to the front of the component chassis 110 and the LED strips 117A, 117B, 117C, 117D. Other connectors 218, such as screw-based connectors or snap in or plug in connectors are used to join other components to the substrate 112 of the component chassis 110, which can make it easy to remove components on the back side or front side of the component chassis 110.

The distributor board 200 brings electrical connections in electrical communication with each of the three shown LED wires 210 to connection pins 202, 204, 206, here shown, respectively, as B+ pins, W− pins, and W−− pins, where the first two provide power to each respective LED strip 117A, 117B, 117C, 117D and the third or any further pins may serve to control dimming, color, data transfer, or other suitable purposes, via communication with the LED wires 210 whose output may be controlled by the LED driver 160 (not shown) on the back side of the component chassis 110.

Also on the component chassis 110 is a pin 142 connected to moveable plate 138 on the opposing side of component chassis 110 that can slide as the pin 142 is moved within the opening 143 from which it projects to cause the movable plate 138 to engage with the frame (not shown). The second end 116 of the component chassis 110 is also shown, as are the first edge 149A and the second edge 149B of the component chassis 110.

A unique coding element 226 is shown attached to the distributor board 200. This may be a QR or bar code that uniquely identifies the component chassis 110. It may be an RFID tag, NFC tag, or other electronically readable tags, etc. In some aspects, it comprises two or more identifying media such as QR code and an electronically readable tag.

FIG. 13 is a photograph of a box 280 containing a set of component chassis 110 as described herein, with a nested stack 284 of lenses 162. This illustrates one way in which a set of component chassis 110 and a similar number of lenses 162, if desired, may be shipped together in a small container. Cushioning material 282 holds the ends of the component chassis 110 and the nested stack 284 of lenses 162. The box 280 as depicted contains six component chassis 110 and six lenses 162, but even more could be fit in the box 280 if desired.

In some alternate aspects, the component chassis 110 may be more directly stacked together with cushioning or protective material (not shown) between adjacent pairs of component chassis 110. In such cases, an arrangement similar to that shown here may be used with adjacent component chassis 110 arranged so that the position of LED drivers 160 alternate from one component chassis 110 to another prevent steric interference.

FIG. 14 is a photo showing a box adapted to contain the components of complete LED luminaires, with multiple frames 150 arranged in a compact nestled stack 285 with pads 151 of deformable material between the individual frames 150. Cushioning material 282 may also be provided to hold one or more ends of the nestled stack 285 of frames 150.

There are spaces 286, 287 at one or more sides of the compact nestled stack 285 which can accommodate the other components, which also may be stacked efficiently and protected in corrugated or paperboard containers, paper padding, wraps, and so forth. Such other components may include lenses 162 (not shown), a set of component chassis 110 (not shown), a box of installation rails (or housing installation brackets) 288 for connecting the frame to existing ceiling openings once used for other luminaires, etc.

With the improved packaging features of the LED luminaires described herein, it is now possible to ship with a gain in efficiency of at least 30%, 35%, 40%, 45%, 50%, or even 60% or higher. For example, consider shipping a batch of LED luminaires described herein each comprising a frame, a component chassis, a lens, and housing installation brackets for connecting the frame to an existing luminaire housing, with 85% of the batch being 2-foot-by-4-foot luminaires and 15% being 2-foot-by-2-foot luminaires. With similarly sized conventional luminaires (still using 85% 2×4 and 15% 2×2), about 1,000 to 2,000 units can fit in a 45-foot intermodal (“high-cube”) shipping container with dimensions of external dimensions of 45 feet (13.72 meters) long, 8 feet (2.44 meters) wide, and 9 feet 6 inches (2.9 meters) tall, and internal dimensions of about 44 feet 5 inches (13.56 meters) long, 7 feet 8 inches (2.35 meters) wide, and 8 feet 10 inches (2.69 meters) tall, with a volume of approximately 3,040 cubic feet (86 cubic meters). But with the improved packaging systems described herein with removable component chassis, stackable frames, and nestable lenses, we have determined that 3,000 luminaires can be shipped in the same space, a 50% gain over the typical upper limit of about 2,000 conventional luminaires. This shipping efficiency represents a significant sustainability gain. Coupling that the with multiple environmental benefits of refurbishing and reusing or upcycling luminaires that would normally be wasted means remarkable sustainability gains are possible as a benefit of the novel design and structure of the LED luminaires described herein.

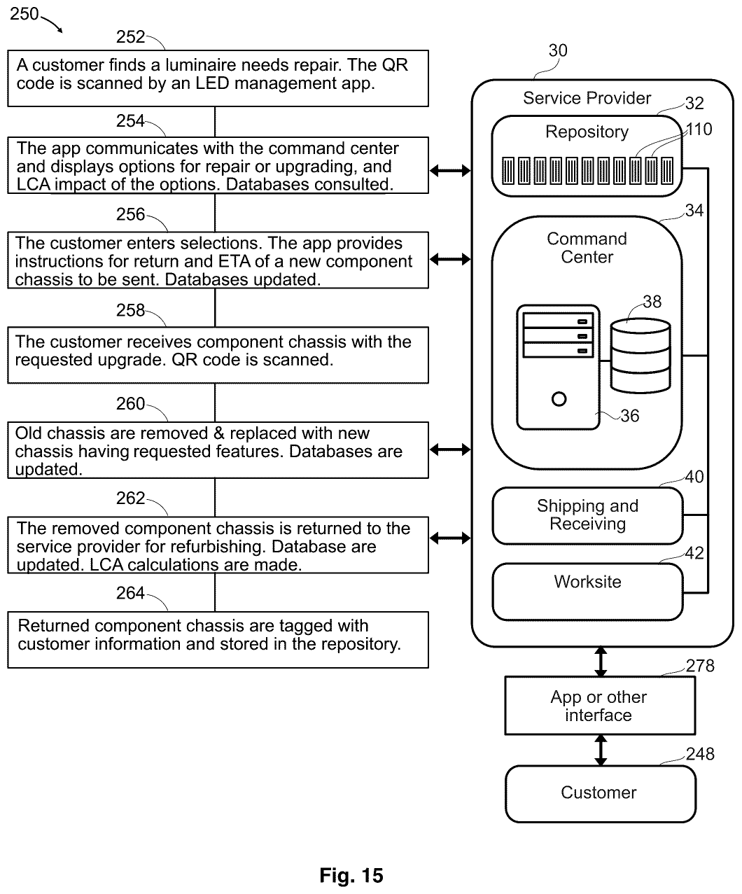

FIG. 15 is a flow diagram of a computer-assisted LED management process 250 that builds on the LED management system 10 of FIG. 1, which includes a service provider 30 having a command center 34 with a database 38 and server 36 for storing information including the geophysical location of LED luminaires (not shown) in the commercial use and in a repository 110 under control of or accessible by the service provider 30. The server 36 may comprise or operate with one or more processor and associated software.

The process 250 begins with step 252 when a customer 248 finds that an existing LED luminaire is in need of repair. The LED luminaire has been previously registered, meaning that its features, ownership, contractual status, history (especially with respect to sustainability factors related to carbon footprint), and geophysical location have been received by the service provider 30 and are stored in the database 38, which may be a plurality of databases accessible by the server 36.

In step 254, an app or other interface tool 278 (e.g., a website, or other computer-assisted service interface, including a telephony center) may be provided by the service provider 30 (directly or indirectly through the assistance of contracted third parties). The app or other interface tool 278 is adapted for use in managing LED resources. In response to a request from the customer 248, which can begin with the scanning of a code on the component chassis 110, for example, of the LED luminaire in question, the app or other interface tool 278 communicates with the command center 34 and displays or otherwise provides options for repair or upgrading. The options may draw upon information in the database 38 that includes contractual details establishing a business relationship between the customer 248 and the service provider 30, details of the LED luminaire in question and the attributes of the component chassis 110, the geophysical location of the LED luminaire, past requests of the customer 248, the history of the LED luminaire and its component chassis 110, and data on manufacturing, transport, recycling, etc., to properly provide meaningful options according the contractual relationship, sales promotions, or other factors. Such data can also be adapted to create sustainability reports or progress charts, or elements of data for an LCA analysis, etc., to assist the customer 248 in its sustainability goals and to properly weigh sustainability and other factors in the decisions the customer makes in light of the need to repair or upgrade one or more components in its lighting resources.

In step 256, the customer 248 makes or enters selections in response to provide options from the service provider 30. The app or other interface tool 278 provides instructions for return and the estimated time of arrival of a new component chassis 110 or whatever other components to be sent. The database 38 associated with or accessible by the service provider 30 or other agent is updated.

In step 258, the customer 248 receives a refurbished component chassis 110 with the requested upgrade. It may be a component chassis 110 previously used by the customer 248, demonstrating an effort for net zero emission and high sustainability that can be documented in a sustainability report based on the stored data from the command center 34 and the service provider 30. As the refurbished (or new) component chassis 110 or other components are received, associated QR codes are scanned and the database 38 is correspondingly updated.

In step 260, the old component chassis 110 is removed (this may be done earlier in the process, not necessarily only after step 258 for example) and is replaced with refurbished (or new) chassis having the requested features. One or more databases such as the database 38 of the command center 34 are updated with the scanned information pertaining to the installed newly received component chassis 110.

In step 262, the removed component chassis 110 is returned to the service provider 30 for refurbishing. Databases such as the database 38 of the command center 34 are updated LCA calculations or other sustainability calculations and reports may be made at this step or at other steps.

In step 264, the returned component chassis 110 are tagged with customer information and stored in the repository, with corresponding updates to databases such as the database 38 of the command center 34 if such updates have not yet been made.

In preparing LCA and sustainability reports or portions thereof for the products handled by the computer-assisted LED management process 250, enhanced detail and accuracy is possible by the tracking of each LED luminaire with a unique identifier (UID) from manufacturing and during use and repair, refurbishment, and upgrading or final recycling and disposal. and its history with respect to employing upcycled or refurbished components. Data collection is generally done as products are installed or removed for return to the service provider 30. Thus, the data tracking system for sustainability analysis extends from manufacturing throughout the lifecycle. Data collection can include information related to raw material sourcing, production energy use, emissions, recycling or upcycling, and waste generation, which may be recorded in the database with respect to each UID. This includes the date of manufacture, type of materials used, energy consumption per unit, and any waste or recycling processes involved at the manufacturing stage and beyond, as well as final material recovery and recycling.

Use and performance modeling information may also be obtained throughout the lifecycle. In collaboration with the user, data from smart sensors, operational hours, modes of operation, energy efficiency, etc. can also be combined with service provider 30 data to provide a more complete sustainability report or LCA analysis. End of life and post-life data may be incorporated into such analysis.

Lifecycle and sustainability data may be stored in a centralized database with access to all data linked to the UIDs of the luminaire or the component chassis. Sustainability analysis software may be deployed to estimate environmental impact, carbon emissions and equivalents, earned tax credits, etc. Such tools may calculate the total environmental impact from cradle to grave, including carbon footprint, energy consumption, and waste generation.

LCA analysis and reporting may be done automatically using collected data to assess the environmental impact over the lifecycle of the luminaire. The data may be used to comply with environmental regulations and standards, and applying for eco-certifications which can be updated directly in the database. LCA analysis may require consideration of factors such as water use which may need to be obtained with additional analysis. Standards used may include ISO 14040:2006 which describes the principles and framework for life cycle assessment (LCA) including: definition of the goal and scope of the LCA, the life cycle inventory analysis (LCI) phase, the life cycle impact assessment (LCIA) phase, the life cycle interpretation phase, reporting and critical review of the LCA, limitations of the LCA, the relationship between the LCA phases, and conditions for use of value choices and optional elements. Likewise, ISO 14044:2006 specifies requirements and provides guidelines for life cycle assessment (LCA). Also to be considered are ISO 14025 on to environmental labels and declarations, often used in conjunction with LCA results and PAS 2050 for the assessment of the life cycle greenhouse gas emissions of goods and services.

### Various Aspects

In a first aspect, a method is described for reducing waste in the replacement, repair, or upgrading of LED luminaires, comprising:
a) providing a customer with a first plurality of LED luminaires for use at one or more locations, each LED luminaire comprising a modular component chassis, a lens, and a frame, wherein the frame is designed to receive the modular component chassis and the lens, wherein the modular component chassis comprises:
i) a substrate,
ii) one or more readily replaceable printed circuit boards attached to the substrate and comprising a plurality of LED lights,
iii) a power receptacle for receiving electrical power;
iv) an LED driver attached to the modular component chassis and electrically connected to the power receptable and to the printed circuit boards via a quick-connect electrical connection;
b) receiving a request for service for a portion of the first plurality of LED luminaires, wherein the requested service requires replacement, repair, or upgrading of the portion of the LED luminaires;
c) sending the customer a number of replacement modular component chassis;
d) receiving the modular component chassis of the portion of the LED luminaires pertaining to the request for service;
e) physically storing the one or more modular component chassis and associating each of the one or more stored modular component chassis with the customer identity or with the one or more locations of the first plurality of LED luminaires, such that the one or more modular component chassis may later be retrieved for subsequent use.

In a second aspect, the method of Aspect 1 is described, wherein in response to a subsequent service request from the customer or for the one or more locations, one or more of the recycled modular component chassis is sent to the customer or to the one or more locations.

In a third aspect, the method of Aspect 1 is described, wherein upgrading or repairing a received modular component chassis comprises at least one of the group consisting of replacing one or more of the printed circuit boards, replacing a module, adding a module, replacing the LED driver, modifying one or more components of the LED driver, replacing one or more LED lights, modifying settings in the received modular component chassis, modifying software or software rights associated with the received modular component chassis, and modifying wiring systems or electrical connections.

In a fourth aspect, the method of Aspect 1 is described, wherein the frame comprises at least one opening, and the component chassis comprises one or more engagement means adapted to engage with the at least one opening of the frame, such that the component chassis can attached to the frame be installed without the need for tools.

In a fifth aspect, the method of Aspect 1 is described, wherein the modular component chassis comprises a plurality of printed circuit boards that are electronically connected one to another using a power distribution board without the need for soldering the printed circuit boards to each other.

In a sixth aspect, the method of Aspect 1 is described, wherein sending the customer a number of replacement modular component chassis comprises sending a carton in which a stack of replacement modular component chassis is shipped with spacer material between each adjacent modular component chassis and is stacked such that the vertical height of occupied by four replacement modular component chassis is no greater than 12 inches.

In a seventh aspect, a method is described for efficient shipping of a plurality of LED luminaires, each luminaire having a modular component chassis, a lens, and rigid frame adapted to be stackable, wherein at least four of the rigid frames can be placed together to form a stack of rigid frames having a height less than 1.5 times the height of a single rigid frame, and wherein the lenses are also adapted to be stackable, wherein at least four of the lenses can be placed together to form a stack of lenses having a height less than 1.5 times the height of a single lens, the method comprising the steps of:
a) forming a stack of rigid frames from the plurality of LED luminaires, wherein spacers are provided between adjacent rigid frames;
b) forming a stack of lenses from the plurality of LED luminaires;
c) forming one or more stacks of the modular component chassis from the plurality of LED luminaires;
d) placing the stacks of the rigid frames, lenses, and modular component chassis into one or more containers; and
e) sending the one or more container to a recipient;
wherein the minimum volume of a parallelepiped capable of containing the stack of rigid frames, the stack of lenses, and the one or more stacks of the modular component chassis divided by the number of luminaires in the plurality of LED luminaires is less than 70% of the minimum volume of a parallelepiped capable of containing one of the plurality of LED luminaires.

In an eighth aspect, a method of is described for replacing, repairing, or upgrading an LED luminaire in a location associated with a user, the LED luminaire comprising a frame and a modular component chassis, wherein the modular component chassis is adapted for tool-less attachment to and removal from the frame, and wherein the modular component chassis comprises a substrate attached to a plurality of components including an LED driver and a plurality of LED lights, the method comprising the steps of:
a) receiving from the user of the LED luminaire a first modular component chassis that has been removed from the frame of the LED luminaire and that has a first set of features,
b) sending the user a second modular component chassis having a second set of features, wherein the second modular component chassis is adapted to be installed into the frame of the LED luminaire without the user of tools;
c) removing any damaged, malfunctioning, or deprecated components from the first modular component chassis;
d) labeling the first modular component chassis as being associated with the user,
e) storing the first modular component chassis until the user wishes to receive another modular component chassis having a third set of features;
f) modifying the first modular component chassis such that it provides the third set of features; and
g) sending the user the modified first modular component chassis.

In a ninth aspect, a method is described for reducing waste when adding, upgrading, retrofitting, or replacing LED luminaires, comprising the steps of:
a) receiving an order for a plurality of LED luminaires, each luminaire comprising a stackable frame, a modular component chassis, and a lens,
b) forming a stack of the stackable frames, wherein the stack comprises a plurality of non-metallic spacers between adjacent stackable frames and wherein the height of the stack divided by the number of stackable frames therein is less than 70% of the height of one stackable frame, each stackable frame being associated with a lens and a modular component chassis,
c) sending the stack of stackable frames and the associated lenses and modular component chassis to a recipient associated with the order.

In a tenth aspect, the method of Aspect 9 is described, further comprising steps of:
d) receiving from an entity associated with the order one or more modular component chassis;
e) removing unwanted or defective components from at least one of the one or more modular component chassis;
f) installing one or more components on at least one of the one or more modular component chassis to form one or more modified modular component chassis;
g) sending the one or more modified modular component chassis to a recipient.

In an eleventh aspect, the method of Aspect 10 is described, further comprising the step of:
d′) storing the one or more modular component chassis until a request for modification to at least one of the one or modular component chassis is received.

In an twelfth aspect, a method is described for reducing waste in the replacement, repair, or upgrading of LED luminaires, comprising:
a) providing a command center comprising a server and an LED database for storing information pertaining to components of LED luminaires,
b) providing a customer with a first plurality of LED luminaires for use at one or more locations, each LED luminaire comprising a modular component chassis, a lens, and a frame, wherein the frame is designed to receive the modular component chassis and the lens, wherein the modular component chassis is associated with a scannable unique identifier that is entered into the database of LED components, and wherein the modular component chassis comprises:
i) a substrate,
ii) one or more readily replaceable printed circuit boards attached to the substrate and comprising a plurality of LED lights,
iii) a power receptacle for receiving electrical power;
iv) an LED driver attached to the modular component chassis and electrically connected to the power receptable and to the printed circuit boards;
c) receiving a request for service for a portion of the first plurality of LED luminaires, wherein the requested service requires replacement, repair, or upgrading the component chassis of the portion of the first plurality of LED luminaires;
d) scanning the unique identifiers of the component chassis of the portion of the first plurality of LED luminaires and updating the associated LED database records to indicate that a request for service has been made;
e) sending the customer a number of replacement modular component chassis, each having its scannable unique identifier stored in the database;
f) receiving the modular component chassis of the first portion of the LED luminaires pertaining to the request for service;
g) removing any of the modular component chassis of the first portion of the LED

luminaires that are unfit for refurbishment to create a serviceable set of component chassis;
e) physically storing the serviceable set of component chassis and associating the unique identifiers of each with the location of physically storage and at least one of the group consisting of the customer identity or the one or more previous locations of the first plurality of LED luminaires prior to being returned, such that the one or more modular component chassis may later be retrieved for subsequent use.

In an thirteenth aspect, a sustainable LED luminaire is described comprising a stackable frame, a lens adapted for toolless installation to and removal from the frame, and a low-profile modular component chassis comprising a substrate, plurality of LED lights attached to the substrate, and an LED driver attached to the substrate, wherein the low-profile modular component chassis is adapted to attach to and detach from the stackable frame without the use of tools and has a height less than 3.2 inches, wherein the stackable frame is adapted to be stacked with 8 identical stackable frames to form a stack having a height less than 5 times the height of one of the stackable frames.

In related aspects, an LED luminaire of particular benefit in improving sustainability issues is provided having (1) a frame having a first end and an opposing second end with a connecting plate (sometimes called a spine or beam) therebetween; (2) an LED component chassis having a substrate (e.g., a metal, composite, of polymeric structure that holds and supports the elements of a component chassis), a printed circuit board (PCB) attached to the substrate or serving as at least part of the substrate, one or more LED lights attached to the substrate, a driver attached to the substrate, and a connector adapted to receive power from a power source, the LED lights being in electrical connection with the driver; (3) a lens adapted for toolless connection to the LED panel; and (4) one or more first engaging elements associated with a first side of the component chassis adapted to attach to one portion of the frame and one or more second engaging elements associated with a second side of the component chassis and adapted to connect with a second portion of the frame, wherein the one or more first engaging elements cooperate with the one or more second engaging elements to hold the component chassis securely in place with respect to the frame, wherein the one or more first engaging elements are also adapted, when the one or more second engaging elements are disconnected from the second portion frame, to hold the component chassis as it hangs from the frame when the frame is horizontal to securely hold the LED component chassis onto the frame. In some aspects, the component chassis can be installed or removed without the need to de-energize the line power that supplies the LED lighting in the area. The power to the LED driver may be disconnected and reconnected to the main power with a simple snap-on connector that does not expose a worker to live wires, although the main power line can be de-energized if desired. In related aspects, connections can be made, components replaced, or the entire component chassis replaced without the need to use tools other than a human hand.

A lens may also be adapted to fit onto the frame or the component chassis, such as a snap-on plastic lens that can be inserted or removed by hand. The lens may be, for example, an injection molded plastic parabolic louver or other louver, or a plastic (e.g., polycarbonate, polymethyl methacrylate acrylic, and silicone). When in place, the lens may have a shape that is substantially that of a semicylinder, an arc, a parabola, a plane, or the like, or any useful shape suitable for a luminaire. The LED luminaire may be provided with more than one lens, if desired.

The lens may be a resilient, flexible polymeric material that can bend enough to engage with slots or grooves on the frame or, in some aspects, with grooves or channels on the component chassis, such as linear grooves or channels running along opposing edges of the component chassis. The lens may be connected or removed without the need for tools. The lens may be adapted to nest together with other lenses, such as being adapted to form a nested stack of at least four lens units, which can help reduced packaging material during shipping.

The component chassis may comprise a heat-conducting component such as a layer of aluminum in thermal contact with, or in proximity to, heat-generating elements such as the one or more LED lights, the printed circuit board, or the driver, etc. In addition to aluminum, other materials may be present such as materials used for printed circuit boards, including materials known as FR-2 (phenolic cotton paper), FR-3 (cotton paper and epoxy), FR-4 (woven glass and epoxy), FR-5 (woven glass and epoxy), FR-6 (matte glass and polyester), G-10 (woven glass and epoxy), CEM-1 (cotton paper and epoxy), CEM-2 (cotton paper and epoxy), CEM-3 (non-woven glass and epoxy), CEM-4 (woven glass and epoxy), CEM-5 (woven glass and polyester), or other materials, including other metals such as copper or silver, and composites with aluminum, copper, or other excellent conductors of heat.

The component chassis may also comprise or be associated with various sensors such as motion detectors, IR sensors, temperature sensors, brightness sensors, color sensors, cameras, RFID antennae and associated circuitry for reading RFID tags, antennae for detecting and transmitting other electromagnetic signals, Bluetooth systems, WIFI systems, telecommunications systems such as 3G, 4G, 5G, and 6G systems, microphones, video cameras, accelerometers, radar systems, LIDAR units, ionization detectors, smoke detectors, humidity sensors, etc. The component chassis may also comprise a microprocessor and a memory in order to receive, process, and transmit information such as signals based on data from sensors associated with the component chassis. Such sensors may be mounted on the substrate of the component chassis or may be mounted elsewhere on or near the frame of the luminaire but in communication with the microprocessor of the gear. Instructions for processing data or for regulating lights or other electronic devices may be stored in the memory. In some aspects, memory need not be mounted on the component chassis but may be remote to the component chassis as long as the component chassis is in communication with the memory.

The one or more LED lights in the LED luminaire may be found in one or more LED panels (e.g., a strip or array), each of which comprises one or more LED lights (e.g., LED chips or cells). The LED lights may be arranged in a predetermined pattern on the strip or panel, and are electrically connected to the driver that may control the amount of current or voltage supplied to each LED light or to the LED panels. The driver may be configured to cooperate with one or more sensors to regulate the current and/or voltage supplied to the LED lights based on various factors, such as the desired brightness, color temperature, or color rendering index (CRI) of the LED luminaire, or in response to motion or the presence of humans and many other factors.

The LED panels or strips may be mounted on a heat sink or other suitable material in the substrate that provides thermal management for the LED lights in addition to providing structural support. The heat sink may be designed to dissipate heat generated by the LED lights, the LED driver, or other components, to promote longevity of the LED luminaire.

The LED luminaire may also include various optical components, such as lenses (which may also be diffusers), diffusers, or reflectors, that are positioned over or near the LED lights to control the direction and distribution of light emitted by the LED luminaire. These optical components may be designed to provide various beam angles, light distributions, or other characteristics depending on the specific application of the LED luminaire.

In operation, the LED luminaire receives power from an external power source, which is typically an AC or DC power supply. In some aspects, the power supply may be direct DC current from solar power, wind power, wave power, or other non-fossil fuel sources, as well as batteries, capacitors, or supercapacitors, or may be any form of AC current and any suitable voltage or amperage. The driver regulates the current and/or voltage supplied to the LED lights based on the input voltage and various control signals, such as those received from a dimmer switch or other control device.

The LED luminaires discussed herein may provided in troffers that may suspend from a ceiling or be fitted in drop-down or T-bar type ceilings, but may also be provided in a non-drop ceiling. They may be installed as replacements for fluorescent lights, mercury lamps, halide lights, etc., or as replacements or upgrades for existing LED lighting.

### Electrical Connectors

A wide variety of electrical connectors may be considered for various connections in the LED luminaire, such as wire-to-wire connectors, wire-to-board connectors, and board-to-board connectors. Electrical connectors that may be used include any suitable NEMA connector, including twist-lock connectors such as NEMA L6 (e.g., L6-20P) or L15 (e.g., L15-30P) connectors. See, for example, https://en.wikipedia.org/wiki/NEMA_connector. Suitable connectors may also be selected from the connection products of companies such as Wago, Molex, TE Connectivity, Amphenol, Hirose Electric, Phoenix Contact, etc.

Connectors for a PCB board that may be part of the substrate or otherwise in electrical communication with the LED lights and LED driver may be of any suitable form, such as rail mount plugs, harness style plus, angled connectors, direct marking connectors, etc. The “Direct marking” connectors are designed to work with pre-printed wire markers, which can be inserted directly into the connector housing to provide identification of the individual wires.

Many examples of suitable connectors are shown, for example, in the catalog of Wago GmbH (Minden, Germany), WAGO PCB Terminal Block and Connectors Full Line Catalog, vol. 2, edition 2021/2022, at https://store-hf5p6bxj3i.mybigcommerce.com/content/wago/catalogs/wago-Full-Line-Catalog-Volume-2-PCB.pdf. Exemplary connections include the 1-conductor female plug MCS MIDI, 722 Series, p. 466, 721 Series, p. 509, and 231 Series, p. 560; 1-conductor male connector MCS MIDI, 721 Series, p. 478; female connector for rail-mount terminal blocks, 722 Series, p. 498; THT male header (harness style), 721 Series, p. 534; Direct Marking MCS MIDI and MCS MIDI Classic male and female connectors, p. 548; THT male header for double-deck assembly, 232 Series, p. 590; PCB connectors and headers, MCS MIDI Classic style, as shown on p. 743, including 1) male headers with angled solder pins, male headers for double-deck assembly, angled female connectors with conductor entry opposite of latches and angled female connector with conductor entry in the same direction as latches; exemplary arrangements as shown on p. 751; 1-conductor female plug, MCS MAXI 16, with level actuation and a push-in Cage Clamp, 832 Series, p. 768; feedthrough terminal blocks, 231, 731 and 226 Series, p. 801; and feedthrough terminal block, 828 Series with CAGE CLAMP® lever mounting actuation and locking claw, 16 square millimeters, and 11.5 mm pin spacing, p. 817. All examples are non-limiting.

In one aspect, connectors are used that can permit the LED component chassis to be removed and installed under full electrical load, such that power does not need to be cut prior to mating and unmating of the connectors that provide power to the LEC component chassis from the power source. Suitable connectors for this purpose include Wago Winstra connectors, including those described at https://www.wago.com/us/discover-pluggable-connectors/winsta. Latching and non-latching connectors may be used.

### Further Remarks

When introducing elements of aspects of the invention or the embodiments thereof, the articles “a,” “an,” “the,” and “said” are intended to mean that there are one or more of the elements, and thus may include plural referents unless the context clearly dictates otherwise. The terms “comprising,” “including,” and “having” are intended to be inclusive and mean that there may be additional elements other than the listed elements.

As used herein, the word “exemplary” means serving as an example, instance, or illustration. The aspects described herein are not limiting but rather are exemplary only. It should be understood that the described aspects are not necessarily to be construed as preferred or advantageous over other aspects. Unless otherwise indicated, no aspect of any invention described herein should be assumed to have the same advantages or features had by any other aspect.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Unless otherwise expressly stated, comparative, quantitative terms such as “less” and “greater”, are intended to encompass the concept of equality. As an example, “less” can mean not only “less” in the strictest mathematical sense, but also, “less than or equal to.”

Having described aspects of the invention in detail, it will be apparent that modifications and variations are possible without departing from the scope of aspects of the invention as defined in the appended claims. As various changes could be made in the above compositions, products, and methods without departing from the scope of aspects of the invention, it is intended that all matter contained in the above description shall be interpreted as illustrative and not in a limiting sense.

While the foregoing description makes reference to particular illustrative aspects, these examples should not be construed as limitations. The inventive system, methods, and products can be adapted for other uses or provided in other forms not explicitly listed above, and can be modified in numerous ways within the spirit of the present disclosure. Thus, the present invention is not limited to the disclosed aspects, but is to be accorded the widest scope consistent with the claims below.

1. A method for reducing waste in the replacement, repair, or upgrading of LED luminaires, comprising:
a) providing a customer with a first plurality of LED luminaires for use at one or more locations, each LED luminaire comprising a modular component chassis, a lens, and a frame, wherein the frame is designed to receive the modular component chassis and the lens, wherein the modular component chassis comprises:
i) a substrate,
ii) one or more readily replaceable printed circuit boards attached to the substrate and comprising a plurality of LED lights,
iii) a power receptacle for receiving electrical power;
iv) an LED driver attached to the modular component chassis and electrically connected to the power receptable and to the printed circuit boards via a quick-connect electrical connection;
b) receiving a request for service for a portion of the first plurality of LED luminaires, wherein the requested service requires replacement, repair, or upgrading of the portion of the LED luminaires;
c) sending the customer a number of replacement modular component chassis;
d) receiving the modular component chassis of the portion of the LED luminaires pertaining to the request for service;
e) physically storing the one or more modular component chassis and associating each of the one or more stored modular component chassis with the customer identity or with the one or more locations of the first plurality of LED luminaires, such that the one or more modular component chassis may later be retrieved for subsequent use.

2. The method of claim 1, wherein in response to a subsequent service request from the customer or for the one or more locations, one or more of the recycled modular component chassis is sent to the customer or to the one or more locations.

3. The method of claim 1, wherein upgrading or repairing a received modular component chassis comprises at least one of the group consisting of replacing one or more of the printed circuit boards, replacing a module, adding a module, replacing the LED driver, modifying one or more components of the LED driver, replacing one or more LED lights, modifying settings in the received modular component chassis, modifying software or software rights associated with the received modular component chassis, and modifying wiring systems or electrical connections.

4. The method of claim 1, further comprising providing command center comprising a server and a database adapted to store geophysical location data for a component chassis having a UID when its UID is scanned, and then scanning the UID of a component chassis when the component chassis is installed at a site associated with the customer.

5. The method of claim 4, receiving a request for service comprises the customer using an app or suitable scanner to scan the component chassis of a luminaire in need of service, and then indicating to a service provider with access to the command center that the scanned component chassis is in need of service.

6. The method of claim 5, further comprising maintaining a repository of returned and/or refurbished component chassis, wherein the UID of each chassis and its geophysical location data is stored in the database, wherein sending the customer a number of replacement modular component chassis comprises searching the database for a suitable component chassis that has been refurbished or can be refurbished to serve as a replacement for the scanned component chassis of a luminaire in need of service, and, when possible, selecting a component chassis that previously belonged to the customer to prepare as a replacement, otherwise selecting another suitable refurbished component chassis from the repository.

7. The method of claim 1, wherein the modular component chassis comprises a plurality of printed circuit boards that are electronically connected one to another using a power distribution board without the need for soldering the printed circuit boards to each other.

8. The method of claim 1, wherein sending the customer a number of replacement modular component chassis comprises sending a carton in which a stack of replacement modular component chassis is shipped with spacer material between each adjacent modular component chassis and is stacked such that the vertical height of occupied by four replacement modular component chassis is no greater than 12 inches.

9. The method of claim 1, wherein sending the customer a number of replacement modular component chassis comprises shipping a compact package comprising at least four refurbished component chassis in a box having at least one dimension less than half the distance required to hold a single luminaire including the frame.

10. A method for replacing, repairing, or upgrading an LED luminaire in a location associated with a user, the LED luminaire comprising a frame and a modular component chassis, wherein the modular component chassis is adapted for tool-less attachment to and removal from the frame, and wherein the modular component chassis comprises a substrate attached to a plurality of components including an LED driver and a plurality of LED lights, and also comprises a UID associated with manufacturing data and geophysical location data in a database of a service provider;
the method comprising the steps of:
a) receiving from the user of the LED luminaire a first modular component chassis that has been removed from the frame of the LED luminaire and that has a first set of features,
b) sending the user a second modular component chassis having a second set of features, wherein the second modular component chassis is adapted to be installed into the frame of the LED luminaire without the user of tools;
c) removing any damaged, malfunctioning, or deprecated components from the first modular component chassis;
d) storing the first modular component chassis in a repository until the user wishes to receive another modular component chassis having a third set of features, the location in the repository being associated with the UID of the first modular component chassis in the database;
f) modifying the first modular component chassis such that it provides the third set of features; and
g) sending the user the modified first modular component chassis.

11. The method of claim 10, further comprising scanning the UID of the the modified first modular component chassis after it is installed by the user, thereby updating the records in the database for the UID to provide the date and location of the installation.

12. A method for reducing waste in the replacement, repair, or upgrading of LED luminaires, comprising:
a) providing a command center comprising a server and an LED database for storing information pertaining to components of LED luminaires,
b) providing a customer with a first plurality of LED luminaires for use at one or more locations, each LED luminaire comprising a modular component chassis, a lens, and a frame, wherein the frame is designed to receive the modular component chassis and the lens, wherein the modular component chassis is associated with a scannable unique identifier that is entered into the database of LED components, and wherein the modular component chassis comprises:
i) a substrate,
ii) one or more readily replaceable printed circuit boards attached to the substrate and comprising a plurality of LED lights,
iii) a power receptacle for receiving electrical power;
iv) an LED driver attached to the modular component chassis and electrically connected to the power receptable and to the printed circuit boards;
c) receiving a request for service for a portion of the first plurality of LED luminaires, wherein the requested service requires replacement, repair, or upgrading the component chassis of the portion of the first plurality of LED luminaires;
d) scanning the unique identifiers of the component chassis of the portion of the first plurality of LED luminaires and updating the associated LED database records to indicate that a request for service has been made;
e) sending the customer a number of replacement modular component chassis, each having its scannable unique identifier stored in the database;
f) receiving the modular component chassis of the first portion of the LED luminaires pertaining to the request for service;
g) removing any of the modular component chassis of the first portion of the LED luminaires that are unfit for refurbishment to create a serviceable set of component chassis;
e) physically storing the serviceable set of component chassis and associating the unique identifiers of each with the location of physically storage and at least one of the group consisting of the customer identity or the one or more previous locations of the first plurality of LED luminaires prior to being returned, such that the one or more modular component chassis may later be retrieved for subsequent use.
